(19) United States
(12) Patent Application Publication
(10) Pub. No.: US 2025/0088891 A1
(43) Pub. Date: Mar. 13, 2025

(54) METHOD AND DEVICE IN NODES USED FOR WIRELESS COMMUNICATION

(71) Applicants: Qi JIANG, Shanghai (CN); Ping WANG, Shanghai (CN); Xiaobo ZHANG, Shanghai (CN)

(72) Inventors: Qi JIANG, Shanghai (CN); Ping WANG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/822,494

(22) Filed: Sep. 3, 2024

(30) Foreign Application Priority Data
Sep. 7, 2023 (CN) 202311153106.0

(51) Int. Cl. H04W 24/10

(52) U.S. Cl. CPC H04W 24/10

(57) ABSTRACT

A first node receives a first reference signal and a second reference signal, a time-frequency resource occupied by the first reference signal and a time-frequency resource occupied by the second reference signal being both associated with a target reference signal resource; and transmits CSI; a measurement of the first reference signal is used to generate the CSI, and the second reference signal is no later than a CSI reference resource for the CSI in time domain; whether a measurement of the second reference signal is used to generate the CSI depends on one of the following: power-related information of the first reference signal and the second reference signal; location-related information of the first node; spatial Rx parameters corresponding to the first reference signal and the second reference signal; or time-domain resources occupied by the first reference signal and the second reference signal.

### CROSS REFERENCE TO RELATED APPLICATIONS

This application claims the priority benefit of Chinese Patent Application No. 202311153106.0, filed on Sep. 7, 2023, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In 2020, the vision of 5.5G industry for 5G evolution was first proposed by the industrial circles. In April 2021, the 3rd Generation Partner Project (3GPP) officially identified the name of 5.5G for 5G evolution as 5G-Advanced, which marks the start of the standardization process, and planned to define the 5G-Advanced technical specifications through Rel-18 (i.e., Release-18), Rel-19 and Rel-20. By the end of 2021, the Rel-18 has approved 28 projects, and 5.5G technology research and standardization has entered a substantial stage. Future Rel-19 and Rel-20 will further explore new 5G-Advanced services and architectures.

Reconfigurable Intelligent Surface (RIS) is an artificial electromagnetic surface structure with programmable electromagnetic properties, containing a large number of independent low-cost passive sub-wavelength resonant units. Each RIS unit has independent electromagnetic wave modulation capability; and the response of each unit to radio signals, such as phase, amplitude, polarization, etc., can be controlled by changing the parameters and spatial distribution of the RIS units. Through the superposition of wireless response signals of a large number of RIS units, specific beam propagation characteristics are formed on the macro level, thus forming a flexible and controllable formed beam to eliminate the coverage of blind zones, enhance the edge of the coverage and achieve the effect of increasing the rank of multi-stream transmission. RIS technology is characterized by low cost, low energy consumption and programmability, and is easy to deploy, and obtains high beamforming gain with larger antenna size, and thus is regarded as a key technology for research in the 5G-Advanced phase and one of the core visions of 6G.

In traditional wireless communications, the UE (i.e., User Equipment) report may include at least one of a variety of auxiliary information, such as CSI, Beam Management-related auxiliary information, localization-related auxiliary information and so on. The CSI includes at least one of CSI-reference signal Resource Indicator (CRI), Rank Indicator (RI), Precoding Matrix Indicator (PMI), or Channel quality indicator (CQI). The network device selects appropriate transmission parameters for the UE based on the UE's report, such as the cell being camped, Modulation and Coding Scheme (MCS), Transmitted Precoding Matrix Indicator (TPMI), Transmission Configuration Indication (TCI) and other parameters. In addition, UE reporting can be used to optimize network parameters such as better cell coverage, switching base station based on UE location, etc.

### SUMMARY

In order to reduce the impact of noise and transient variations on the CSI estimation and to improve the stability of the signal quality estimation, the UE makes multiple measurements of the same CSI-RS (i.e., Channel State Information Reference Signal) resource within a certain time window and filters these measurement result s to obtain more reliable CSI values, which can reduce the effect of random noise, and counteract transient variations caused by short-term channel fading. In the existing standards, the base station (BTS) can configure higher layer parameters according to the network demand and optimization strategy to limit the time window of channel measurement. It defines the duration of CSI measurement in a specific time period, and how to perform the filtering operation and what algorithm or weight allocation strategy to use specifically depends on the actual implementation and network configuration, different vendors and systems may use different methods to process the measurement results in the same CSI-RS resource and generate the finally reported CSI values. However, the RIS scenario may introduce additional signal attenuation due to the loss of reflection paths, and the reference signals sent by the BTS in the same antenna port (group) may have different spatial reception directions for the receiving terminal in terms of direct and reflected paths, which affects the accuracy and reliability of the CSI-RS measurements: therefore, the CSI reporting in the RIS scenario is a problem that needs to be solved.

To address the above problem, the present application provides a solution. It should be noted that although the original intent of this application is for RIS scenarios, this application can also be applied to other non-RIS scenarios; further, the adoption of a unified design scheme for different scenarios (e.g., other non-RIS scenarios including, but not limited to, capacity augmentation systems, systems for near field communications, unlicensed spectrum communications, Internet of Things (IoT), Ultra Reliable Low Latency Communication (URLLC) networks, Vehicle-to-everything (V2X), etc.) also helps to reduce hardware complexity and cost. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

Particularly, for interpretations of the terminology; nouns, functions and variables (unless otherwise specified) in the present application, refer to definitions given in TS38 series and TS37 series of 3GPP specifications. Refer to 3GPP TS38.211, TS38.212, TS38.213, TS38.214, TS38.215, TS38.300, TS38.304, TS38.305, TS38.321, TS38.331, TS37.355, and TS38.423, if necessary, for a better understanding of the present application.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a first reference signal and a second reference signal, a time-frequency resource occupied by the first reference signal and a time-frequency resource occupied by the second reference signal being both associated with a target reference signal resource; and
transmitting channel state information (CSI);
herein, a measurement of the first reference signal is used to generate the CSI, and the second reference signal is no later than a CSI reference resource for the CSI in time domain; whether a measurement of the second reference signal is used to generate the CSI depends on one of the following:
   power-related information of the first reference signal and power-related information of the second reference signal;
   location-related information of the first node;
   spatial reception (Rx) parameter(s) corresponding to the first reference signal and spatial Rx parameter(s) corresponding to the second reference signal: or
   a time-domain resource occupied by the first reference signal and a time-domain resource occupied by the second reference signal.

In one embodiment, a problem to be solved in the present application includes: how the first node determines channel state information in a RIS scenario.

In one embodiment, a problem to be solved in the present application includes: whether multiple measurements by the first node within a certain time window for reference signals whose time-frequency resources are associated with a same reference signal resource are all used to generate the channel state information in the RIS scenario.

In one embodiment, characteristics of the above method include that the first node in the present application determines, based on power-related information of a plurality of reference signals whose time-frequency resources are associated with the same reference signal resource, whether the measurements for the plurality of reference signals are all used for generating the channel state information, thereby solving the above problem.

In one embodiment, characteristics of the above method include that the first node in the present application determines, based on location-related information of the first node, whether measurements for the plurality of reference signals whose time-frequency resources are associated with the same reference signal resource are all used for generating the channel state information, thereby solving the above problem.

In one embodiment, characteristics of the above method include that the first node in the present application judges, based on spatial reception parameter(s) of a plurality of reference signals whose time-frequency resources are associated with the same reference signal resource, whether the measurements for the plurality of reference signals are all used for generating the channel state information, thereby solving the above problem.

In one embodiment, characteristics of the above method include that the first node in the present application determines, based on time-domain resources of the plurality of reference signals whose time-frequency resources are associated with the same reference signal resource, whether the measurements for the plurality of reference signals are all used for generating the channel state information, thereby solving the above problem.

In one embodiment, characteristics of the above method include that the channel properties, transmission loss, interference and anti-interference capability, etc., are significantly different among the incident link from the base station to the RIS, the reflective link from the RIS to the terminal, and the direct link from the base station to the terminal, etc., and the first node may determine in an implicit manner, based on power-related information, corresponding spatial reception parameters, and occupied time-domain resources of a plurality of reference signals whose time-frequency resources are associated to the same reference signal resource, as well as location-related information of the first node, whether there is a large difference in the transmission paths of the plurality of reference signals, and the accuracy of the channel estimation can be improved by not performing additional smoothing filtering processing between the measurement results when there is a large difference in the channel properties of the transmission paths, and the like.

In one embodiment, characteristics of the above method include that a transmission path of the first reference signal includes a link consisting of an incident link from a base station to RIS and a reflective link from RIS to a terminal, while a transmission path of the second reference signal includes a direct link from a base station to a terminal

In one embodiment, characteristics of the above method include that a transmission path of the first reference signal includes a direct link from a base station to a terminal, while a transmission path of the second reference signal includes a link consisting of an incident link from a base station to RIS and a reflective link from RIS to a terminal.

In one embodiment, the benefits of the above method include that this application supports RIS technology, which has the advantages of eliminating coverage blind zones, enhancing edge coverage and increasing rank for multi-stream transmission.

In one embodiment, the benefits of the above method include that the first node implicitly determines whether multiple reference signals associated with the same reference signal resource are all used to generate channel state information without additional signaling indication, thus saving signaling overhead and improving spectrum resource utilization.

In one embodiment, the benefits of the above method include that it facilitates the provision of more accurate channel state information, reflecting the real fading situation.

In one embodiment, the benefits of the above method include that it helps the base station to understand the channel properties more accurately and optimize resource allocation and scheduling.

In one embodiment, the benefits of the above method include that it facilitates better perception of the interference situation and adopts corresponding interference management strategies to improve system capacity and performance.

According to one aspect of the present application, the above method is characterized in that reception power of the first reference signal is equal to a first power value, while reception power of the second reference signal is equal to a second power value: an absolute value of a difference between the first power value and the second power value is greater than a first threshold, and the measurement of the second reference signal is not used to generate the CSI: or, the absolute value of the difference between the first power value and the second power value is no greater than the first threshold, and the measurement of the second reference signal is used to generate the CSI.

In one embodiment, characteristics of the above method include that an absolute value of the difference between the first power value and the second power value being greater than a first threshold denotes that there is a large difference in transmission pathloss between the first reference signal and the second reference signal, which implicitly indicates that the transmission path of one of the first reference signal and the second reference signal includes a link consisting of an incident link from a base station to RIS and a reflective link from RIS to a terminal.

In one embodiment, characteristics of the above method include that the present application is applicable to scenarios where the transmission power of the first reference signal is the same as the transmission power of the second reference signal.

In one embodiment, the benefits of the above method include: saving signaling overhead without requiring additional signaling indication, and increasing spectrum resource utilization.

In one embodiment, the benefits of the above method include that it facilitates the provision of more accurate channel state information, reflecting the real fading situation.

In one embodiment, the benefits of the above method include that it facilitates power control and resource allocation by the base station according to the specific situation, so as to reduce the system power consumption and prolong the endurance time of the equipment.

According to one aspect of the present application, the above method is characterized in that there is a change between location-related information corresponding to the first node when receiving the first reference signal and location-related information corresponding to the first node when receiving the second reference signal, and the measurement of the second reference signal is not used to generate the CSI: or, there is no change between the location-related information corresponding to the first node when receiving the first reference signal and the location-related information corresponding to the first node when receiving the second reference signal, and the measurement of the second reference signal is used to generate the CSI.

In one embodiment, characteristics of the above method include that there is a change between location-related information corresponding to the first node when receiving the first reference signal and location-related information corresponding to the first node when receiving the second reference signal, implicitly indicating that the transmission paths of the first reference signal and the second reference signal may differ significantly:

In one embodiment, characteristics of the above method include that there is a change between location-related information corresponding to the first node when receiving the first reference signal and location-related information corresponding to the first node when receiving the second reference signal, implicitly indicating that the location of the first node has changed from being inside the RIS coverage to being outside the RIS coverage, or that the location of the first node has changed from being outside the RIS coverage to being inside the RIS coverage.

In one embodiment, the benefits of the above method include: saving signaling overhead without requiring additional signaling indication, and increasing spectrum resource utilization.

In one embodiment, the benefits of the above method include: facilitating enhanced coverage and improving the quality of service and coverage of the system.

In one embodiment, the benefits of the above method include: facilitating improved mobility support and mobility management based on channel properties of the transmission path.

According to one aspect of the present application, the above method is characterized in that the spatial Rx parameter(s) corresponding to the first reference signal and the spatial Rx parameter(s) corresponding to the second reference signal are different, and the measurement of the second reference signal is not used to generate the CSI: or, the spatial Rx parameter(s) corresponding to the first reference signal and the spatial Rx parameter(s) corresponding to the second reference signal are identical, and the measurement of the second reference signal is used to generate the CSI.

In one embodiment, characteristics of the above method include that the spatial Rx parameter(s) corresponding to the first reference signal includes (include) a spatial Rx parameter employed by the first node when receiving the first reference signal: the spatial Rx parameter(s) corresponding to the second reference signal includes (include) a spatial Rx parameter employed by the first node when receiving the second reference signal.

In one embodiment, characteristics of the above method include that the spatial Rx parameter(s) corresponding to the first reference signal and the spatial Rx parameter(s) corresponding to the second reference signal being different denotes a change in the spatial orientation of the first node with respect to the serving cell, which in turn indicates a change in whether or not the first node is located in the coverage of RIS.

In one embodiment, the benefits of the above method include: saving signaling overhead without requiring additional signaling indication, and increasing spectrum resource utilization.

In one embodiment, the benefits of the above method include: facilitating enhanced coverage and improving the quality of service and coverage of the system.

In one embodiment, the benefits of the above method include: facilitating improved mobility support and mobility management based on channel properties of the transmission path.

According to one aspect of the present application, the above method is characterized in that a location of a time-domain resource occupied by the first reference signal in one slot being configured and a location of a time-domain resource occupied by the second reference signal in one slot being configured are different, and the measurement of the second reference signal is not used to generate the CSI: or, a location of a time-domain resource occupied by the first reference signal in one slot being configured and a location of a time-domain resource occupied by the second reference signal in one slot being configured are identical, and the measurement of the second reference signal is used to generate the CSI.

In one embodiment, characteristics of the above method include that a reference signal reflected via the RIS may introduce additional delay, a location of a time-domain resource occupied by the first reference signal in one slot being configured is different from a location of a time-domain resource occupied by the second reference signal in one slot being configured, implicitly indicating that the transmission path of one of the first reference signal and the second reference signal includes a link consisting of an incident link from a base station to RIS and a reflective link from RIS to a terminal.

In one embodiment, characteristics of the above method include that by artificially introducing an additional delay in a reference signal reflected via the RIS for the operation of the RIS, a location of a time-domain resource occupied by the first reference signal in one slot being configured is different from a location of a time-domain resource occupied by the second reference signal in one slot being configured, implicitly indicating that the transmission path of one of the first reference signal and the second reference signal includes a link consisting of an incident link from a base station to RIS and a reflective link from RIS to a terminal.

In one embodiment, the benefits of the above method include: saving signaling overhead without requiring additional signaling indication, and increasing spectrum resource utilization.

In one embodiment, the benefits of the above method include: having good forward compatibility.

According to one aspect of the present application, the above method is characterized in comprising:
receiving a first information block;
herein, the first information block is used to configure or trigger a CSI report being associated with the target reference signal resource, the CSI report including the CSI.

In one embodiment, characteristics of the above method include that the first reference signal is associated with the CSI report.

In one embodiment, characteristics of the above method include that the second reference signal is associated with the CSI report.

In one embodiment, the benefits of the above method include: having good backward compatibility.

In one embodiment, the benefits of the above method include: saving signaling overhead.

According to one aspect of the present application, the above method is characterized in that the first reference signal and the second reference signal correspond to the same quasi co-location relationship.

In one embodiment, characteristics of the above method include that the first node in the present application is unable to determine a transmission path of the first reference signal and the second reference signal based on quasi-co-location information of the first reference signal and the second reference signal.

In one embodiment, characteristics of the above method include that the first reference signal and the second reference signal in the present application correspond to a same reference signal resource.

In one embodiment, characteristics of the above method include that the first reference signal and the second reference signal in the present application are quasi-co-located with a same reference signal resource.

In one embodiment, the benefits of the above method include: simplifying system design and reducing system complexity:

In one embodiment, the benefits of the above method include: enabling a unified resource allocation strategy and more efficient utilization of resources.

In one embodiment, the benefits of the above method include: simplifying interference management and suppression strategies, and improving spectrum utilization.

According to one aspect of the present application, the above method is characterized in that the first node is a UE.

According to one aspect of the present application, the above method is characterized in that the first node is a relay node.

The present application provides a method in a second node for wireless communications, comprising:
transmitting a first reference signal and a second reference signal, a time-frequency resource occupied by the first reference signal and a time-frequency resource occupied by the second reference signal being both associated with a target reference signal resource; and
receiving channel state information (CSI);
herein, a receiver of the first reference signal and the second reference signal includes a first node: a measurement of the first reference signal is used by the first node to generate the CSI, and the second reference signal is no later than a CSI reference resource for the CSI in time domain: whether a measurement of the second reference signal from the first node is used by the first node to generate the CSI depends on one of the following:
   power-related information of the first reference signal and power-related information of the second reference signal;
   location-related information of the first node;
   spatial reception (Rx) parameter(s) corresponding to the first reference signal and spatial Rx parameter(s) corresponding to the second reference signal: or
   a time-domain resource occupied by the first reference signal and a time-domain resource occupied by the second reference signal.

According to one aspect of the present application, the above method is characterized in that reception power of the first reference signal is equal to a first power value, while reception power of the second reference signal is equal to a second power value: an absolute value of a difference between the first power value and the second power value is greater than a first threshold, and the measurement of the second reference signal is not used to generate the CSI: or, the absolute value of the difference between the first power value and the second power value is no greater than the first threshold, and the measurement of the second reference signal is used to generate the CSI.

According to one aspect of the present application, the above method is characterized in that there is a change between location-related information corresponding to the first node when receiving the first reference signal and location-related information corresponding to the first node when receiving the second reference signal, and the measurement of the second reference signal is not used to generate the CSI: or, there is no change between the location-related information corresponding to the first node when receiving the first reference signal and the location-related information corresponding to the first node when receiving the second reference signal, and the measurement of the second reference signal is used to generate the CSI.

According to one aspect of the present application, the above method is characterized in that the spatial Rx parameter(s) corresponding to the first reference signal and the spatial Rx parameter(s) corresponding to the second reference signal are different, and the measurement of the second reference signal is not used to generate the CSI: or, the spatial Rx parameter(s) corresponding to the first reference signal and the spatial Rx parameter(s) corresponding to the second reference signal are identical, and the measurement of the second reference signal is used to generate the CSI.

According to one aspect of the present application, the above method is characterized in that a location of a time-domain resource occupied by the first reference signal in one slot being configured and a location of a time-domain resource occupied by the second reference signal in one slot being configured are different, and the measurement of the second reference signal is not used to generate the CSI; or, a location of a time-domain resource occupied by the first reference signal in one slot being configured and a location of a time-domain resource occupied by the second reference signal in one slot being configured are identical, and the measurement of the second reference signal is used to generate the CSI.

According to one aspect of the present application, the above method is characterized in comprising:
transmitting a first information block;
herein, the first information block is used to configure or trigger a CSI report being associated with the target reference signal resource, the CSI report including the CSI.

According to one aspect of the present application, the above method is characterized in that the first reference signal and the second reference signal correspond to the same quasi co-location relationship.

According to one aspect of the present application, the above method is characterized in that the second node is a base station.

According to one aspect of the present application, the above method is characterized in that the second node is a serving cell.

According to one aspect of the present application, the above method is characterized in that the second node is a serving cell of the first node.

According to one aspect of the present application, the above method is characterized in that the second node is a UE.

According to one aspect of the present application, the above method is characterized in that the second node is a relay node.

The present application provides a first node for wireless communications, comprising:
a first receiver, receiving a first reference signal and a second reference signal, a time-frequency resource occupied by the first reference signal and a time-frequency resource occupied by the second reference signal being both associated with a target reference signal resource; and
a first transmitter, transmitting channel state information (CSI);
herein, a measurement of the first reference signal is used to generate the CSI, and the second reference signal is no later than a CSI reference resource for the CSI in time domain; whether a measurement of the second reference signal is used to generate the CSI depends on one of the following:
   power-related information of the first reference signal and power-related information of the second reference signal;
   location-related information of the first node;
   spatial reception (Rx) parameter(s) corresponding to the first reference signal and spatial Rx parameter(s) corresponding to the second reference signal: or
   a time-domain resource occupied by the first reference signal and a time-domain resource occupied by the second reference signal.

The present application provides a second node for wireless communications, comprising:
a second transmitter, transmitting a first reference signal and a second reference signal, a time-frequency resource occupied by the first reference signal and a time-frequency resource occupied by the second reference signal being both associated with a target reference signal resource; and
a second receiver, receiving channel state information (CSI);
herein, a receiver of the first reference signal and the second reference signal includes a first node: a measurement of the first reference signal is used by the first node to generate the CSI, and the second reference signal is no later than a CSI reference resource for the CSI in time domain; whether a measurement of the second reference signal from the first node is used by the first node to generate the CSI depends on one of the following:
   power-related information of the first reference signal and power-related information of the second reference signal;
   location-related information of the first node;
   spatial reception (Rx) parameter(s) corresponding to the first reference signal and spatial Rx parameter(s) corresponding to the second reference signal: or
   a time-domain resource occupied by the first reference signal and a time-domain resource occupied by the second reference signal.

In one embodiment, compared with the prior art, the present application is advantageous in, but not limited to, the following aspects:
it is beneficial for correct estimation of the channel, improves the transmission quality and anti-interference capability, and thus increases the system capacity;
it supports RIS technology, which has the advantages of eliminating coverage blind zones, enhancing edge coverage and increasing rank for multi-stream transmission;
it requires no additional signaling indication, thus saving signaling overhead and improving spectrum resource utilization.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission between a first node and a second node according to one embodiment of the present application.

FIG. 6 illustrates a schematic diagram of reception power of a first reference signal, reception power of a second reference signal and a first threshold according to one embodiment of the present application.

FIG. 7 illustrates a schematic diagram of a case of locational change for the first node when receiving a first reference signal and a second reference signal according to one embodiment of the present application.

FIG. 8 illustrates a schematic diagram of a case of change in spatial Rx parameters for the first node when receiving a first reference signal and a second reference signal according to one embodiment of the present application.

FIG. 9 illustrates a schematic diagram of two cases of locations of time-domain resources respectively occupied in a configured slot by a first reference signal and a second reference signal according to one embodiment of the present application.

FIG. 10 illustrates a schematic diagram of the quasi co-location relationship between a first reference signal and a second reference signal according to one embodiment of the present application.

FIG. 11 illustrates a schematic diagram of Reconfigurable Intelligence Surface (RIS) according to one embodiment of the present application.

FIG. 12 illustrates a structure block diagram of a processing device used in a first node according to one embodiment of the present application.

FIG. 13 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

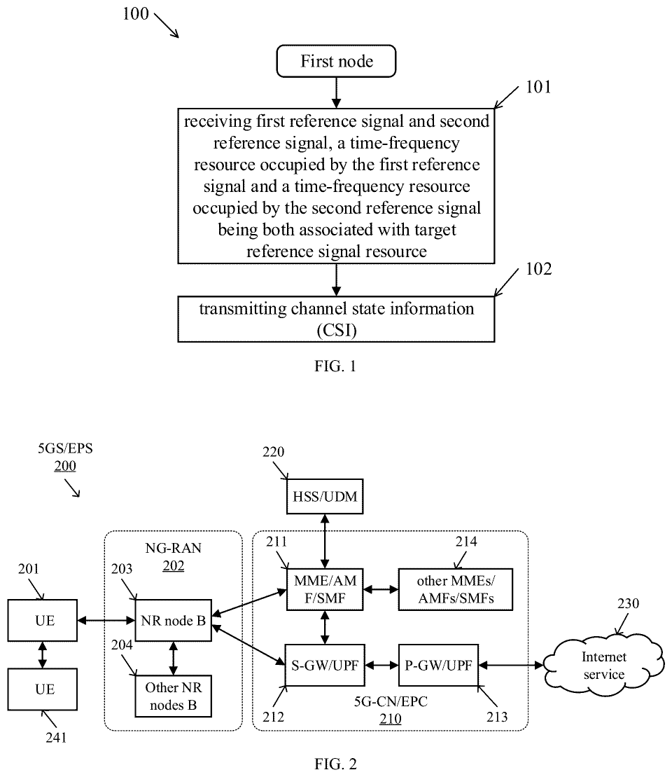

Embodiment 1 illustrates a flowchart of transmission of a first node according to one embodiment of the present application, as shown in FIG. 1. In FIG. 1, each box represents a step. Particularly, the sequential step arrangement in each box herein does not imply a chronological order of steps marked respectively by these boxes.

The first node receives a first reference signal and a second reference signal in step 101, a time-frequency resource occupied by the first reference signal and a time-frequency resource occupied by the second reference signal being both associated with a target reference signal resource; and transmits channel state information (CSI) in step 102.

In Embodiment 1, a measurement of the first reference signal is used to generate the CSI, and the second reference signal is no later than a CSI reference resource for the CSI in time domain; whether a measurement of the second reference signal is used to generate the CSI depends on one of the following:
power-related information of the first reference signal and power-related information of the second reference signal;
location-related information of the first node;
spatial reception (Rx) parameter(s) corresponding to the first reference signal and spatial Rx parameter(s) corresponding to the second reference signal: or
a time-domain resource occupied by the first reference signal and a time-domain resource occupied by the second reference signal.

In one embodiment, the CSI refers to Channel State Information.

In one embodiment, the first reference signal corresponds to a Period (P) RS resource.

In one embodiment, the first reference signal corresponds to a Semi-Persistent (SP) RS resource.

In one embodiment, the first reference signal comprises a Channel State Information-Reference Signal (CSI-RS).

In one subembodiment, the first reference signal comprises a CSI-RS transmitted in a slot.

In one subembodiment, the first reference signal corresponds to a CSI-RS transmitted in a slot.

In one embodiment, the first reference signal comprises an SSB.

In one subembodiment, the first reference signal comprises an SSB transmitted in a slot.

In one subembodiment, the first reference signal corresponds to an SSB transmitted in a slot.

In one embodiment, the SSB in this application refers to: Synchronization Signal Block.

In one embodiment, the SSB in this application refers to: Synchronization Signal/Physical Broadcast CHannel (SS/PBCH) block.

Typically, the reception occasion of PBCH, Primary Synchronization Signal (PSS) and Secondary Synchronization Signal (SSS) lies in consecutive symbols and thus forms an SS/PBCH block.

In one embodiment, the first reference signal corresponds to a CSI-RS resource.

In one embodiment, the first reference signal corresponds to a non-zero-power (NZP) CSI-RS resource.

In one embodiment, the first reference signal corresponds to a Reference Signal (RS) Resource Identification (Id).

In one embodiment, the RS Resource Id in this application is used to identify one RS resource.

In one embodiment, the RS Resource Id in this application is an index of one RS resource.

In one embodiment, the RS Resource Id in this application comprises a configuration index of one RS resource.

In one embodiment, the RS resource Id in this application is a configuration index of one RS resource.

In one embodiment, the first reference signal corresponds to an NZP-CSI-RS-ResourceId.

In one embodiment, the first reference signal corresponds to a Transmission Configuration Indicator (TCI) state.

In one embodiment, the first reference signal corresponds to a TCI-StateId.

In one embodiment, the first reference signal corresponds to an SSB-Index.

In one embodiment, the first reference signal corresponds to an ssb-Index.

In one embodiment, the second reference signal corresponds to a Period (P) RS resource.

In one embodiment, the second reference signal corresponds to a Semi-Persistent (SP) RS resource.

In one embodiment, the second reference signal comprises a CSI-RS.

In one subembodiment, the second reference signal comprises a CSI-RS transmitted in a slot.

In one subembodiment, the second reference signal corresponds to a CSI-RS transmitted in a slot.

In one embodiment, the second reference signal comprises an SSB.

In one subembodiment, the second reference signal comprises an SSB transmitted in a slot.

In one subembodiment, the second reference signal corresponds to an SSB transmitted in a slot.

In one embodiment, the second reference signal corresponds to a CSI-RS resource.

In one embodiment, the second reference signal corresponds to an NZP CSI-RS resource.

In one embodiment, the second reference signal corresponds to an RS resource Id.

In one embodiment, the second reference signal corresponds to an NZP-CSI-RS-Resourceld.

In one embodiment, the second reference signal corresponds to a TCI state.

In one embodiment, the second reference signal corresponds to a TCI-StateId.

In one embodiment, the second reference signal corresponds to an SSB-Index.

In one embodiment, the second reference signal corresponds to an ssb-Index.

In one embodiment, the second reference signal and the first reference signal correspond to the same one periodic RS resource.

In one embodiment, the second reference signal and the first reference signal correspond to the same one semi-persistent RS resource.

In one embodiment, the second reference signal and the first reference signal correspond to the same one CSI-RS resource.

In one embodiment, the second reference signal and the first reference signal correspond to the same one NZP CSI-RS resource.

In one embodiment, the second reference signal and the first reference signal correspond to the same one RS resource Id.

In one embodiment, the second reference signal and the first reference signal correspond to the same one NZP-CSI-RS-ResourceId.

In one embodiment, the second reference signal and the first reference signal correspond to the same one TCI state.

In one embodiment, the second reference signal and the first reference signal correspond to the same one TCI-StateId.

In one embodiment, the second reference signal and the first reference signal correspond to the same one SSB-Index.

In one embodiment, the second reference signal and the first reference signal correspond to the same one ssb-Index.

In one embodiment, the second reference signal is later than the first reference signal in time domain. In one embodiment, the second reference signal is earlier than the first reference signal in time domain.

In one embodiment, the time-domain resource occupied by the second reference signal belongs to a second slot and the time-domain resource occupied by the first reference signal belongs to a first slot, the second slot being different from the first slot.

In one embodiment, the time-domain resource occupied by the second reference signal belongs to a second slot and the time-domain resource occupied by the first reference signal belongs to a first slot, the second slot being later than the first slot.

In one embodiment, the time-domain resource occupied by the second reference signal belongs to a second slot and the time-domain resource occupied by the first reference signal belongs to a first slot, the first slot being later than the second slot.

In one embodiment, the target reference signal resource corresponds to a Period (P) RS resource.

In one subembodiment, both the second reference signal and the first reference signal correspond to the Period RS resource that the target reference signal resource corresponds to.

In one embodiment, the target reference signal resource comprises a Period (P) RS resource.

In one embodiment, the target reference signal resource is a Period (P) RS resource.

In one embodiment, the target reference signal resource corresponds to a Semi-Persistent (SP) RS resource.

In one subembodiment, both the second reference signal and the first reference signal correspond to the SP RS resource that the target reference signal resource corresponds to.

In one embodiment, the target reference signal resource comprises a Semi-Persistent (SP) RS resource.

In one embodiment, the target reference signal resource is a Semi-Persistent (SP) RS resource.

In one embodiment, the target reference signal resource corresponds to a CSI-RS resource.

In one subembodiment, both the second reference signal and the first reference signal correspond to the CSI-RS resource that the target reference signal resource corresponds to.

In one embodiment, the target reference signal resource comprises a CSI-RS resource.

In one embodiment, the target reference signal resource is a CSI-RS resource.

In one embodiment, the target reference signal resource is a Period (P) CSI-RS resource.

In one embodiment, the target reference signal resource corresponds to a NZP CSI-RS resource.

In one subembodiment, both the second reference signal and the first reference signal correspond to the NZP CSI-RS resource that the target reference signal resource corresponds to.

In one embodiment, the target reference signal resource comprises a NZP CSI-RS resource.

In one embodiment, the target reference signal resource is a NZP CSI-RS resource.

In one embodiment, the target reference signal resource corresponds to an RS resource Id.

In one subembodiment, both the second reference signal and the first reference signal correspond to the RS resource Id that the target reference signal resource corresponds to.

In one embodiment, the target reference signal resource corresponds to an NZP-CSI-RS-Resourceld.

In one subembodiment, both the second reference signal and the first reference signal correspond to the NZP-CSI-RS-Resourceld that the target reference signal resource corresponds to.

In one embodiment, the target reference signal resource corresponds to an SSB.

In one subembodiment, both the second reference signal and the first reference signal correspond to the SSB that the target reference signal resource corresponds to.

In one embodiment, the target reference signal resource comprises an SSB.

In one embodiment, the target reference signal resource is an SSB resource.

In one embodiment, the target reference signal resource corresponds to an SSB-Index.

In one subembodiment, both the second reference signal and the first reference signal correspond to the SSB-Index that the target reference signal resource corresponds to.

In one embodiment, the target reference signal resource corresponds to an ssb-Index.

In one subembodiment, both the second reference signal and the first reference signal correspond to the ssb-Index that the target reference signal resource corresponds to.

In one embodiment, the target reference signal resource corresponds to a TCI state.

In one subembodiment, both the second reference signal and the first reference signal correspond to the TCI state that the target reference signal resource corresponds to.

In one embodiment, the target reference signal resource corresponds to a TCI-StateId.

In one subembodiment, both the second reference signal and the first reference signal correspond to the TCI-StateId that the target reference signal resource corresponds to.

In one embodiment, the target reference signal resource is associated to 1 CSI-ReportConfigld.

In one embodiment, the target reference signal resource comprises one or more port(s).

In one subembodiment, the one or more port(s) is/are respectively CSI-RS port(s).

In one subembodiment, the one or more port(s) is/are respectively antenna port(s).

In one embodiment, the target reference signal resource comprises a reference signal.

In one embodiment, the target reference signal resource comprises a reference signal being transmitted in the target reference signal resource.

In one embodiment, both the first reference signal and the second reference signal correspond to a CSI-RS resource that the target reference signal resource corresponds to.

In one embodiment, a time-frequency resource occupied by the first reference signal comprises at least one Resource Element (RE).

In one embodiment, a time-frequency resource occupied by the second reference signal comprise at least one RE.

Typically; the one RE occupies a symbol in the time domain and a subcarrier in the frequency domain.

In one embodiment, the target reference signal resource comprises at least one symbol in a slot in the time domain.

In one embodiment, the target reference signal resource comprises multiple symbols in a slot in the time domain.

In one embodiment, the target reference signal resource comprises multiple slots in the time domain.

In one embodiment, the target reference signal resource comprises multiple sub-frames in the time domain.

In one embodiment, the target reference signal resource comprises at least one sub-band in the frequency domain.

In one embodiment, the target reference signal resource comprises at least one Resource Block (RB) in the frequency domain.

Typically, the one RB comprises 12 consecutive subcarriers in the frequency domain.

In one embodiment, the target reference signal resource comprises a set of downlink Physical RBs (PRBs).

In one embodiment, the RB in the present application includes PRB.

In one embodiment, the RB in the present application refers to PRB.

In one embodiment, the symbol in the present application includes multi-carrier symbol.

In one embodiment, a time-frequency resource occupied by the target reference signal resource comprise at least one RE.

In one embodiment, the multi-carrier symbol in the present application is a Single Carrier-Frequency Division Multiple Access (SC-FDMA) symbol.

In one embodiment, the multi-carrier symbol in the present application is a Filter Bank Multi Carrier (FBMC) symbol.

In one embodiment, the multi-carrier symbol in the present application is an Orthogonal Frequency Division Multiplexing (OFDM) Symbol.

In one embodiment, the symbol in the present application is obtained by an output by transform precoding through OFDM Symbol Generation.

In one embodiment, the multi-carrier symbol in the present application is a Discrete Fourier Transform-spread-OFDM (DFT-s-OFDM) symbol.

In one embodiment, the multicarrier symbol in the present application comprises a Cyclic Prefix (CP).

In one embodiment, a time-frequency resource configured for the target reference signal resource comprises a time-frequency resource occupied by the first reference signal.

In one embodiment, a time-frequency resource configured for transmission of a reference signal in the target reference signal resource comprises a time-frequency resource occupied by the first reference signal.

In one embodiment, the first reference signal is transmitted in accordance with configuration information of the target reference signal resource.

In one embodiment, the first reference signal is transmitted in one occurrence of the target reference signal resource in time domain.

In one embodiment, the first reference signal is a reference signal transmission according to configuration information of the target reference signal resource.

In one embodiment, a time-frequency resource configured for the target reference signal resource comprises a time-frequency resource occupied by the second reference signal.

In one embodiment, a time-frequency resource configured for transmission of a reference signal in the target reference signal resource comprises a time-frequency resource occupied by the second reference signal.

In one embodiment, the second reference signal is transmitted in accordance with configuration information of the target reference signal resource.

In one embodiment, the second reference signal is transmitted in one occurrence of the target reference signal resource in time domain.

In one embodiment, the second reference signal is a reference signal transmission according to configuration information of the target reference signal resource.

In one embodiment, a time-frequency resource configured for the target reference signal resource comprises a time-frequency resource occupied by the first reference signal and a time-frequency resource occupied by the second reference signal.

In one embodiment, a time-frequency resource configured for transmission of a reference signal in the target reference signal resource comprises a time-frequency resource occupied by the first reference signal and a time-frequency resource occupied by the second reference signal.

In one embodiment, the first reference signal and the second reference signal are both transmitted in accordance with configuration information of the target reference signal resource.

In one embodiment, the first reference signal and the second reference signal are each transmitted in one occurrence of the target reference signal resource in time domain.

In one embodiment, the first reference signal and the second reference signal are each a reference signal transmission according to configuration information of the target reference signal resource.

In one embodiment, the configuration information of a reference signal resource includes part or all of a time-domain resource, a frequency-domain resource, a Code Division Multiplexing type (CDM type), a scramblingID, periodicity, QCL, density; a number of port(s), a cycle shift, an Orthogonal Cover Code (OCC), a transmission sequence, or a TCI.

In one embodiment, the QCL in this application refers to Quasi Co-Location.

In one embodiment, the QCL in this application refers to Quasi Co-Located.

In one embodiment, the QCL in this application comprises QCL parameters.

In one embodiment, the QCL in this application comprises QCL assumption.

In one embodiment, the QCL type in this application includes TypeA, TypeB, TypeC and TypeD.

In one embodiment, the QCL type in this application includes Type(s) other than TypeA, TypeB, TypeC and TypeD.

In one embodiment, the QCL type in this application includes TypeE, TypeF and TypeG.

In one embodiment, the QCL parameters in the present application of which the QCL type is TypeA include a Doppler shift, a Doppler spread, an average delay and a delay spread: the QCL parameters in the present application of which the QCL type is TypeB include a Doppler shift and a Doppler spread: the QCL parameters in the present application of which the QCL type is TypeC include a Doppler shift and an average delay: the QCL parameters in the present application of which the QCL type is TypeD include a spatial Rx parameter.

In one embodiment, the QCL in the present application includes at least one of a Doppler shift, a Doppler spread, an average delay, a delay spread, a Spatial Tx parameter or a Spatial Rx parameter.

In one embodiment, for detailed meaning of the TypeA, the TypeB, the TypeC and the TypeD of the present application, refer to TS 38.214, Section 5.1.5.

In one embodiment, the TypeE, the TypeF and the TypeG in this application apply to QCL types after Rel-18 (i.e., Release-18).

In one embodiment, the TypeE, the TypeF and the TypeG in this application apply to QCL types after Rel-19.

In one embodiment, the TypeE, the TypeF and the TypeG in this application apply to QCL types after Rel-20.

In one embodiment, the QCL-Type corresponding to the target reference signal resource is one of TypeA, TypeB, TypeC or TypeD.

In one embodiment, the QCL-Type corresponding to the target reference signal resource is a Type other than TypeA, TypeB, TypeC or TypeD.

In one embodiment, the QCL-Type corresponding to the target reference signal resource is one of TypeE, TypeF or TypeG.

In one embodiment, the channel state information comprises a baseband signal.

In one embodiment, the channel state information comprises an RF signal.

In one embodiment, the channel state information comprises a radio signal.

In one embodiment, the channel state information comprises CSI.

In one embodiment, the channel state information comprises a Channel Quality Indicator (CQI).

In one embodiment, the channel state information comprises a wideband CQI.

In one embodiment, the channel state information comprises at least one subband CQI.

In one embodiment, the channel state information comprises a Precoding Matrix Indicator (PMI).

In one embodiment, the channel state information comprises a CSI-RS Resource Indicator (CRI).

In one embodiment, the channel state information comprises an SSB Resource Indicator (SSBRI).

In one embodiment, the channel state information comprises a Layer Indicator (LI).

In one embodiment, the channel state information comprises a Rank Indicator (RI).

In one embodiment, the channel state information comprises a Layer 1 Reference Signal Received Power (L1-RSRP)

In one embodiment, the channel state information comprises a Layer 1 Signal to Noise and Interference Ratio (L1-SINR).

In one embodiment, the channel state information comprises a Capability Index.

In one embodiment, the channel state information comprises a capability set index.

In one embodiment, the channel state information comprises at least one of a CQI, a PMI, a CRI, an SSBRI, a LI, a RI, a L1-RSRP, a L1-SINR, a capability index or a capability set index.

In one embodiment, the channel state information comprises a measurement report.

In one embodiment, the channel state information comprises a result of Cell Selection.

In one embodiment, the channel state information comprises a result of Beam Failure Recovery (BFR).

In one embodiment, the channel state information comprises a report of mobility measurement.

In one embodiment, a higher layer parameter timeRestrictionForChannelMeasurements of the CSI-reportConfig associated with the channel state information is set to “notConfigured”.

In one embodiment, the measurement of the first reference signal includes channel measurement.

In one embodiment, the measurement of the first reference signal is channel measurement.

In one embodiment, the measurement of the first reference signal includes Interference Measurement (IM).

In one embodiment, the measurement of the first reference signal includes Layer 1 (L1) measurement.

In one embodiment, the measurement of the first reference signal includes Layer 3 (L3) measurement.

In one embodiment, the measurement of the first reference signal is used for generating the channel state information.

In one embodiment, the measurement of the first reference signal is used for generating a CSI.

In one embodiment, the measurement of the first reference signal is used for generating a measurement report.

In one embodiment, the measurement of the first reference signal is used for mobility management.

In one embodiment, the measurement of the first reference signal is used for cell selection or re-selection.

In one embodiment, the first node obtains a channel measurement for calculating the channel state information based on the measurement of the first reference signal.

In one embodiment, the first node obtains an interference measurement for calculating the channel state information based on the measurement of the first reference signal.

In one embodiment, the second reference signal is not later in the time domain than a CSI reference resource for the channel state information.

In one embodiment, the second reference signal is earlier in the time domain than a CSI reference resource for the channel state information.

In one embodiment, the measurement of the second reference signal includes channel measurement.

In one embodiment, the measurement of the second reference signal is channel measurement.

In one embodiment, the measurement of the second reference signal includes interference measurement.

In one embodiment, the measurement of the second reference signal includes L1 measurement.

In one embodiment, the measurement of the second reference signal includes L3 measurement.

In one embodiment, the measurement of the second reference signal is used for generating the channel state information.

In one embodiment, the measurement of the second reference signal is not used for generating the channel state information.

In one embodiment, the measurement of the second reference signal is used for generating a CSI.

In one embodiment, the measurement of the second reference signal is not used for generating a CSI.

In one embodiment, the measurement of the second reference signal is used for generating a measurement report.

In one embodiment, the measurement of the second reference signal is not used for generating a measurement report.

In one embodiment, the measurement of the second reference signal is used for mobility management.

In one embodiment, the measurement of the second reference signal is not used for mobility management.

In one embodiment, the measurement of the second reference signal is used for cell selection or re-selection.

In one embodiment, the measurement of the second reference signal is not used for cell selection or re-selection.

In one embodiment, the first node obtains a channel measurement for calculating the channel state information based on the measurement of the second reference signal.

In one embodiment, the first node, based on the measurement of the second reference signal, is not used to obtain a channel measurement for calculating the channel state information.

In one embodiment, the first node obtains an interference measurement for calculating the channel state information based on the measurement of the second reference signal.

In one embodiment, the first node, based on the measurement of the second reference signal, is not used to obtain an interference measurement for calculating the channel state information.

In one embodiment, the measurement of the second reference signal and the measurement of the first reference signal are used together for generating the channel state information.

In one embodiment, the measurement of the second reference signal and the measurement of the first reference signal are used together for generating a CSI.

In one embodiment, the measurement of the second reference signal and the measurement of the first reference signal are used together for generating a measurement report.

In one embodiment, the measurement of the second reference signal and the measurement of the first reference signal are used together for mobility management.

In one embodiment, the measurement of the second reference signal and the measurement of the first reference signal are used together for cell selection or re-selection.

In one embodiment, the first node obtains a channel measurement for calculating the channel state information based on the measurement of the second reference signal and the measurement of the first reference signal together.

In one embodiment, the first node obtains an interference measurement for calculating the channel state information based on the measurement of the second reference signal and the measurement of the first reference signal together.

In general, how to calculate the channel state information is determined by the hardware device vendor itself, and an unrestricted implementation with respect to CQI is described below as an example:

The first node firstly performs channel measurements for a CSI-RS resource to obtain a channel parameter matrix H_{r×t}, where r and t are the number of receiving antennas and the number of antenna ports used for transmitting, respectively; and under the condition of employing a precoding matrix W_{t×l}, the precoded channel parameter matrix is H_{r×t}·W_{t×l}, where l is the rank or number of layers; using, for example, SINR, EESM (i.e., Exponential Effective SINR Mapping), or RBIR (i.e., Received Block mean mutual Information Ratio) criterion to calculate the equivalent channel capacity of H_{r×t}·W_{t×l}, and then the CQI is determined from the equivalent channel capacity by looking up the table. Generally, the calculation of the equivalent channel capacity requires the estimation of noise and interference performed by the first node. In general, the mapping between the equivalent channel capacity and the value of the CQI is dependent on hardware related factors such as receiver's performance or modulation mode. The precoding matrix Wtxt is usually sent as feedback by the first node via RI or PMI.

In contrast to CQI, L1-SINR does not carry information about the receiver, thus omitting the calculation of the equivalent channel capacity as described above.

In one embodiment, the measurement of the first reference signal is used to estimate the channel parameter matrix H_{r×t}.

In one embodiment, the measurement of the first reference signal is used to estimate interference and/or noise.

In one embodiment, the measurement of the second reference signal is used to estimate the channel parameter matrix H_{r×t}.

In one embodiment, the measurement of the second reference signal is not used to estimate the channel parameter matrix H_{r×t}.

In one embodiment, the measurement of the second reference signal is used to estimate interference and/or noise.

In one embodiment, the measurement of the second reference signal is not used to estimate interference and/or noise.

In one embodiment, the measurement of the second reference signal and the measurement of the first reference signal are used together to estimate the channel parameter matrix H_{r×t}.

In one embodiment, the measurement of the second reference signal and the measurement of the first reference signal are used together to estimate interference and/or noise.

In one embodiment, whether a measurement of the second reference signal is used to generate the channel state information depends on power-related information of the first reference signal and power-related information of the second reference signal.

In one embodiment, the power-related information of the first reference signal comprises a transmission power value of the first reference signal and the power-related information of the second reference signal comprises a transmission power value of the second reference signal, and whether a measurement of the second reference signal is used to generate the channel state information depends on the transmission power value of the first reference signal and the transmission power value of the second reference signal.

In one subembodiment, the transmission power value of the first reference signal is different from the transmission power value of the second reference signal, and the measurement of the second reference signal is not used to generate the channel state information: or, the transmission power value of the first reference signal is the same as the transmission power value of the second reference signal, and the measurement of the second reference signal is used to generate the channel state information.

In one subembodiment, an absolute value of the difference between the transmission power value of the first reference signal and the transmission power value of the second reference signal is greater than a given threshold, and the measurement of the second reference signal is not used to generate the channel state information: or, the absolute value of the difference between the transmission power value of the first reference signal and the transmission power value of the second reference signal is no greater than a given threshold, and the measurement of the second reference signal is used to generate the channel state information: the given threshold is fixed or the given threshold is configured by higher-layer signaling.

In one subembodiment, the transmission power of the first reference signal comprises an Energy Per Resource Element (EPRE) of the first reference signal: the transmission power of the second reference signal comprises an EPRE of the second reference signal.

In one subembodiment, the transmission power of the first reference signal comprises a power value of the first reference signal over one RE: the transmission power of the second reference signal comprises a power value of the second reference signal over one RE.

In one subembodiment, the transmission power of the first reference signal is in dBm (which means deciBel relative to one milliwatt): the transmission power of the second reference signal is in dBm.

In one subembodiment, the transmission power of the first reference signal is in milliwatt (mW): the transmission power of the second reference signal is in mW.

In one subembodiment, the transmission power of the first reference signal is in dB (which means deciBel, decibel): the transmission power of the second reference signal is in dB.

In one embodiment, the power-related information of the first reference signal comprises a reception power value of the first reference signal and the power-related information of the second reference signal comprises a reception power value of the second reference signal, and whether a measurement of the second reference signal is used to generate the channel state information depends on the reception power value of the first reference signal and the reception power value of the second reference signal.

In one subembodiment, an absolute value of the difference between the reception power value of the first reference signal and the reception power value of the second reference signal is greater than a given threshold, and the measurement of the second reference signal is not used to generate the channel state information: or, the absolute value of the difference between the reception power value of the first reference signal and the reception power value of the second reference signal is no greater than a given threshold, and the measurement of the second reference signal is used to generate the channel state information: the given threshold is fixed or the given threshold is configured by higher-layer signaling.

In one embodiment, the power-related information of the first reference signal comprises a pathloss determined according to the first reference signal, and the power-related information of the second reference signal comprises a pathloss determined according to the second reference signal, and whether a measurement of the second reference signal is used to generate the channel state information depends on the pathloss determined according to the first reference signal and the pathloss determined according to the second reference signal.

In one subembodiment, an absolute value of the difference between the pathloss determined according to the first reference signal and the pathloss determined according to the second reference signal is greater than a given threshold, and the measurement of the second reference signal is not used to generate the channel state information: or, the absolute value of the difference between the pathloss determined according to the first reference signal and the pathloss determined according to the second reference signal is no greater than a given threshold, and the measurement of the second reference signal is used to generate the channel state information; the given threshold is fixed or the given threshold is configured by higher-layer signaling.

In one embodiment, whether a measurement of the second reference signal is used to generate the channel state information depends on location-related information of the first node.

In one embodiment, the location-related information of the first node comprises location-related information corresponding to a location of the first node when receiving the first reference signal and location-related information corresponding to a location of the first node when receiving the second reference signal.

In one subembodiment, the location-related information corresponding to the location of the first node at the time of receiving the first reference signal comprises the longitude and latitude at which the first node is located at the time of receiving the first reference signal, and the location-related information corresponding to the location of the first node at the time of receiving the second reference signal comprises the longitude and latitude at which the first node is located at the time of receiving the second reference signal.

In one subsidiary embodiment of the above subembodiment, the longitude and latitude at which the first node is located at the time of receiving the first reference signal is different from the longitude and latitude at which the first node is located at the time of receiving the second reference signal, and the measurement of the second reference signal is not used to generate the channel state information: or, the longitude and latitude at which the first node is located at the time of receiving the first reference signal is the same as the longitude and latitude at which the first node is located at the time of receiving the second reference signal, and the measurement of the second reference signal is used to generate the channel state information.

In one subsidiary embodiment of the above subembodiment, the longitude and latitude at which the first node is located at the time of receiving the first reference signal and the longitude and latitude at which the first node is located at the time of receiving the second reference signal do not belong to the same one longitude-latitude interval, and the measurement of the second reference signal is not used to generate the channel state information: or, the longitude and latitude at which the first node is located at the time of receiving the first reference signal and the longitude and latitude at which the first node is located at the time of receiving the second reference signal belong to the same one longitude-latitude interval, and the measurement of the second reference signal is used to generate the channel state information.

In one subembodiment, the location-related information corresponding to the location of the first node at the time of receiving the first reference signal comprises the elevation at which the first node is located at the time of receiving the first reference signal, and the location-related information corresponding to the location of the first node at the time of receiving the second reference signal comprises the elevation at which the first node is located at the time of receiving the second reference signal.

In one subsidiary embodiment of the above subembodiment, the elevation at which the first node is located at the time of receiving the first reference signal is different from the elevation at which the first node is located at the time of receiving the second reference signal, and the measurement of the second reference signal is not used to generate the channel state information: or, the elevation at which the first node is located at the time of receiving the first reference signal is the same as the elevation at which the first node is located at the time of receiving the second reference signal, and the measurement of the second reference signal is used to generate the channel state information.

In one subsidiary embodiment of the above subembodiment, a relative height between the elevation at which the first node is located at the time of receiving the first reference signal and the elevation at which the first node is located at the time of receiving the second reference signal is greater than a given threshold, and the measurement of the second reference signal is not used to generate the channel state information: or, a relative height between the elevation at which the first node is located at the time of receiving the first reference signal and the elevation at which the first node is located at the time of receiving the second reference signal is no greater than a given threshold, and the measurement of the second reference signal is used to generate the channel state information: the given threshold is fixed or the given threshold is configured by higher-layer signaling.

In one embodiment, whether a measurement of the second reference signal is used to generate the channel state information depends on spatial Rx parameter(s) corresponding to the first reference signal and spatial Rx parameter(s) corresponding to the second reference signal.

In one embodiment, the spatial Rx parameter(s) corresponding to the first reference signal includes (include) a spatial Rx parameter employed by the first node when receiving the first reference signal; the spatial Rx parameter(s) corresponding to the second reference signal includes (include) a spatial Rx parameter employed by the first node when receiving the second reference signal.

In one subembodiment, the spatial Rx parameter(s) corresponding to the first reference signal includes (include) at least one of a receiving beam, a receiving analog beamforming matrix, a receiving analog beamforming vector, a receiving beamforming matrix, a receiving beamforming vector, or a spatial reception filter employed by the first node when receiving the first reference signal: the spatial Rx parameter(s) corresponding to the second reference signal includes (include) at least one of a receiving beam, a receiving analog beamforming matrix, a receiving analog beamforming vector, a receiving beamforming matrix, a receiving beamforming vector, or a spatial reception filter employed by the first node when receiving the second reference signal.

In one subembodiment, at least one of the spatial Rx parameter(s) employed by the first node when receiving the first reference signal is different from at least one of the spatial Rx parameter(s) employed by the first node when receiving the second reference signal, and the measurement of the second reference signal is not used to generate the CSI: or, the spatial Rx parameter(s) employed by the first node when receiving the first reference signal is/are each identical to the spatial Rx parameter(s) employed by the first node when receiving the second reference signal, and the measurement of the second reference signal is used to generate the CSI.

In one subembodiment, the spatial Rx parameter(s) employed by the first node when receiving the first reference signal is/are each different from the spatial Rx parameter(s) employed by the first node when receiving the second reference signal, and the measurement of the second reference signal is not used to generate the CSI; or, at least one of the spatial Rx parameter(s) employed by the first node when receiving the first reference signal is identical to at least one of the spatial Rx parameter(s) employed by the first node when receiving the second reference signal, and the measurement of the second reference signal is used to generate the CSI.

In one embodiment, whether a measurement of the second reference signal is used to generate the channel state information depends on the time-domain resource occupied by the first reference signal and the time-domain resource occupied by the second reference signal.

In one embodiment, the time-domain resource occupied by the first reference signal comprises a location of a multicarrier symbol occupied by the first reference signal in one slot, while the time-domain resource occupied by the second reference signal comprises a location of a multicarrier symbol occupied by the second reference signal in one slot.

In one subembodiment, the location of the multicarrier symbol occupied by the first reference signal in one slot and the location of the multicarrier symbol occupied by the second reference signal in one slot are different, and the measurement of the second reference signal is not used to generate the CSI: or, the location of the multicarrier symbol occupied by the first reference signal in one slot and the location of the multicarrier symbol occupied by the second reference signal in one slot are identical, and the measurement of the second reference signal is used to generate the CSI.

In one embodiment, the time-domain resource occupied by the first reference signal comprises a location of a slot occupied by the first reference signal in one configuration period, while the time-domain resource occupied by the second reference signal comprises a location of a slot occupied by the second reference signal in one configuration period.

In one subembodiment, the location of the slot occupied by the first reference signal in one configuration period and the location of the slot occupied by the second reference signal in one configuration period are different, and the measurement of the second reference signal is not used to generate the CSI: or, the location of the slot occupied by the first reference signal in one configuration period and the location of the slot occupied by the second reference signal in one configuration period are identical, and the measurement of the second reference signal is used to generate the CSI.

### Embodiment 2

Embodiment 2 illustrates a schematic diagram of a network architecture according to one embodiment of the present application, as shown in FIG. 2.

FIG. 2 illustrates a network architecture of Long-Term Evolution (LTE), Long-Term Evolution Advanced (LTE-A) and future 5G systems. The network architecture of the LTE, LTE-A and future 5G systems may be called an Evolved Packet System (EPS). The 5G NR or LTE network architecture may be referred to as 5G System (5GS)/EPS 200 or some other suitable terminology: The 5GS/EPS 200 may comprise one or more UEs 201, a UE 241 in sidelink communication with the UE(s) 201, an NG-RAN 202, a 5G Core Network/Evolved Packet Core (5G-CN/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201—oriented user plane and control plane terminations. The gNB 203 can be connected to other gNBs 204 via an Xn interface (like backhaul). The gNB 203 may be called a base station, a base transceiver station, a radio base station, a radio transceiver, a transceiver function, a Basic Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5G-CN/EPC 210 via an SI/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212. The S-GW/UPF 212 itself is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and packet switching (PS) services.

In one embodiment, the first node in the present application includes the UE 201.

In one embodiment, the second node in the present application includes the gNB203.

In one embodiment, the UE 201 includes cellphone.

In one embodiment, the UE 201 is a means of transportation including automobile.

In one embodiment, the gNB 203 is a Macro Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station supporting large time-delay difference.

In one embodiment, the gNB203 is a flight platform.

In one embodiment, the gNB203 is satellite equipment.

In one embodiment, the gNB 203 is a piece of test equipment (e.g., a transceiving device simulating partial functions of the base station, or a signaling test instrument).

In one embodiment, a radio link from the UE 201 to the gNB 203 is an uplink, the uplink being used for performing uplink transmission.

In one embodiment, a radio link from the gNB 203 to the UE 201 is a downlink, the downlink being used for performing downlink transmission.

In one embodiment, a radio link between the UE201 and the gNB203 includes a cellular link.

In one embodiment, the UE 201 and the gNB 203 are connected to each other via a Uu air interface.

In one embodiment, the transmitter of the first reference signal and the second reference signal includes the gNB 203.

In one embodiment, the receiver of the first reference signal and the second reference signal includes the UE 201.

In one embodiment, the transmitter of the channel state information includes the UE 201.

In one embodiment, the receiver of the channel state information includes the gNB 203.

In one embodiment, the UE 201 supports Reconfigurable Intelligent Surface (RIS).

In one embodiment, the gNB 203 supports RIS.

### Embodiment 3

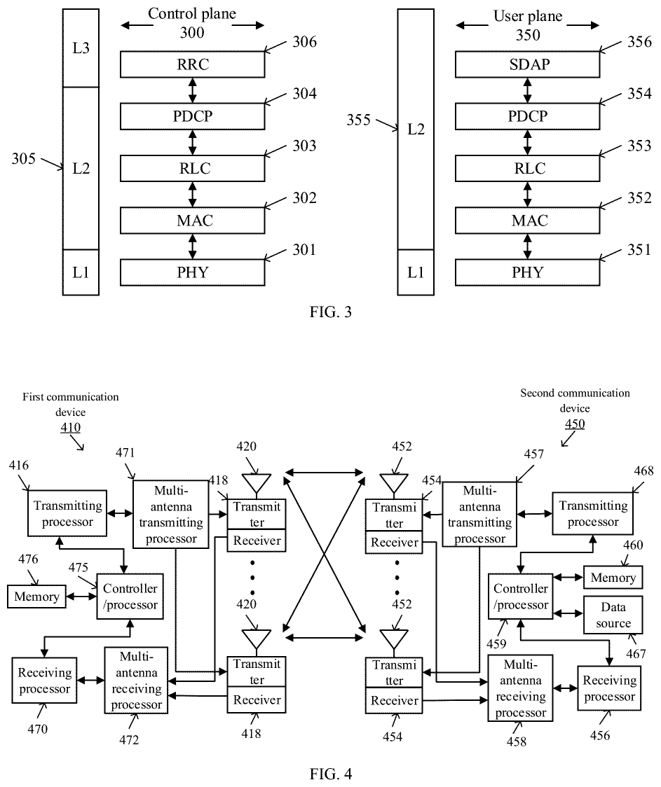

Embodiment 3 illustrates a schematic diagram of an example of a radio protocol architecture of a user plane and a control plane according to the present application, as shown in FIG. 3.

FIG. 3 is a schematic diagram illustrating an embodiment of a radio protocol architecture of a user plane 350 and a control plane 300. In FIG. 3, the radio protocol architecture for a control plane 300 between a first communication node (UE, or Road Side Unit/RSU in Vehicle to Everything (V2X), vehicle-mounted equipment or vehicle-mounted communication module) and a second node (gNB, UE, or RSU in V2X, vehicle-mounted equipment or vehicle-mounted communication module), or between two UEs is represented by three layers, i.e., Layer 1 (L1), Layer 2 (L2) and Layer 3 (L3). The L1 is the lowest layer which performs various signal processing functions of PHY (i.e., PHYsical layer). The L1 is called PHY 301 in the present application. The L2 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., Internet Protocol/IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the channel state information is generated by the PHY 301 or the PHY 351.

In one embodiment, the higher layer in the present application refers to a layer above the PHY layer.

In one embodiment, the higher layer in the present application comprises a MAC layer.

In one embodiment, the higher layer in the present application comprises an RRC layer.

### Embodiment 4

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 and the mapping of signal clusters corresponding to each modulation scheme (i.e., Binary Phase Shift Keying (BPSK), Quadrature Phase Shift Keying (QPSK), M-PSK, and M-Quadrature Amplitude Modulation (M-QAM), etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream to a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna. Each receiver 454 recovers information modulated to the RF carrier, and converts the radio frequency stream into a baseband multicarrier symbol stream to be provided to the receiving processor 456. The receiving processor 456 and the multi-antenna receiving processor 458 provide various signal processing functions of the L1. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using Fast Fourier Transform (FFT). In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2. The controller/processor 459 can be associated with a memory 460 that stores program code and data. The memory 460 may be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2. Or various control signals can be provided to the L3 for processing. The controller/processor 459 also performs error detection using ACKnowledgement (ACK) and/or Negative ACKnowledgement (NACK) protocols as a way to support HARQ operation.

In a transmission from the second communication device 450 to the first communication device 410, at the second communication device 450, the data source 467 is used to provide a higher layer packet to the controller/processor 459. The data source 467 represents all protocol layers above the L2. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including codebook-based precoding and non-codebook-based precoding, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1. The controller/processor 475 provides functions of the L2. The controller/processor 475 can be associated with the memory 476 that stores program code and data. The memory 476 may be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocol to support HARQ operation.

In one embodiment, the second communication device 450 comprises at least one processor and at least one memory: The at least one memory comprises computer program codes: the at least one memory and the computer program codes are configured to be used in collaboration with the at least one processor. The second communication device 450 at least receives a first reference signal and a second reference signal, a time-frequency resource occupied by the first reference signal and a time-frequency resource occupied by the second reference signal being both associated with a target reference signal resource; and transmits channel state information (CSI): a measurement of the first reference signal is used to generate the CSI, and the second reference signal is no later than a CSI reference resource for the CSI in time domain: whether a measurement of the second reference signal is used to generate the CSI depends on one of the following:
power-related information of the first reference signal and power-related information of the second reference signal;
location-related information of the first node;
spatial reception (Rx) parameter(s) corresponding to the first reference signal and spatial Rx parameter(s) corresponding to the second reference signal: or
a time-domain resource occupied by the first reference signal and a time-domain resource occupied by the second reference signal.

In one embodiment, the second communication device 450 comprises a memory that stores a computer readable instruction program. The computer readable instruction program generates actions when executed by at least one processor. The actions include: receiving a first reference signal and a second reference signal; and transmitting channel state information (CSI).

In one embodiment, the first communication device 410 comprises at least one processor and at least one memory: The at least one memory comprises computer program codes: the at least one memory and the computer program codes are configured to be used in collaboration with the at least one processor. The first communication device 410 at least transmits a first reference signal and a second reference signal, a time-frequency resource occupied by the first reference signal and a time-frequency resource occupied by the second reference signal being both associated with a target reference signal resource; and receives channel state information (CSI): a measurement of the first reference signal is used by the receiver of the first reference signal and the second reference signal to generate the CSI, and the second reference signal is no later than a CSI reference resource for the CSI in time domain; whether a measurement of the second reference signal is used by the receiver of the first reference signal and the second reference signal to generate the CSI depends on one of the following:
power-related information of the first reference signal and power-related information of the second reference signal;
location-related information of the receiver of the first reference signal and the second reference signal;
spatial reception (Rx) parameter(s) corresponding to the first reference signal and spatial Rx parameter(s) corresponding to the second reference signal: or
a time-domain resource occupied by the first reference signal and a time-domain resource occupied by the second reference signal.

In one embodiment, the first communication device 410 comprises a memory that stores a computer readable instruction program. The computer readable instruction program generates actions when executed by at least one processor. The actions include: transmitting a first reference signal and a second reference signal; and receiving channel state information (CSI).

In one embodiment, the first node in the present application comprises the second communication device 450.

In one embodiment, the second node in the present application comprises the first communication device 410.

In one embodiment, at least one of the antenna 420, the transmitter 418, the transmitting processor 416, the multi-antenna transmitting processor 471, the controller/processor 475 or the memory 476 is used for transmitting the first reference signal and the second reference signal: at least one of the antenna 452, the receiver 454, the receiving processor 456, the multi-antenna receiving processor 458, the controller/processor 459, the memory 460 or the data source 467 is used for receiving the first reference signal and the second reference signal.

In one embodiment, at least one of the antenna 452, the transmitter 454, the transmitting processor 468, the multi-antenna transmitting processor 457, the controller/processor 459, the memory 460 or the data source 467 is used for transmitting the CSI; at least one of the antenna 420, the receiver 418, the receiving processor 470, the multi-antenna receiving processor 472, the controller/processor 475, or the memory 476 is used for receiving the CSI.

### Embodiment 5

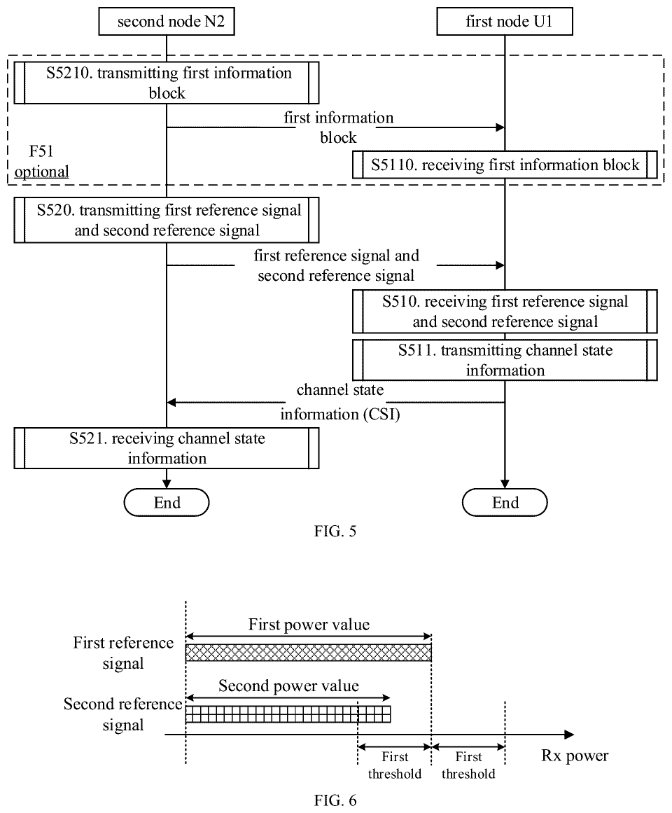

Embodiment 5 illustrates a flowchart of transmission between a first node and a second node according to one embodiment of the present application. In FIG. 5, a first node U1 and a second node N2 are in communication via a radio link, where the steps marked by the box 51 are optional. It should be particularly noted that the sequence illustrated herein does not set any limit to the signal transmission order or implementation order in the present application;

The first node U1 receives a first information block in step S5110; receives a first reference signal and a second reference signal in step S510; and transmits channel state information (CSI) in step S511.

The second node N2 discovers the first information block in step S5210; transmits the first reference signal and the second reference signal in step S520; and receives the CSI in step S521.

In Embodiment 5, a time-frequency resource occupied by the first reference signal and a time-frequency resource occupied by the second reference signal are both associated with a target reference signal resource; and a measurement of the first reference signal is used by the first node U1 to generate the CSI, and the second reference signal is no later than a CSI reference resource for the CSI in time domain; whether a measurement of the second reference signal is used by the first node U1 to generate the CSI depends on one of the following:
power-related information of the first reference signal and power-related information of the second reference signal;
location-related information of the first node U1;
spatial reception (Rx) parameter(s) corresponding to the first reference signal and spatial Rx parameter(s) corresponding to the second reference signal; or
a time-domain resource occupied by the first reference signal and a time-domain resource occupied by the second reference signal.

In one embodiment, the first node U1 is the first node in the present application.

In one embodiment, the second node N2 is the second node in the present application.

In one embodiment, an air interface between the second node N2 and the first node U1 includes a radio interface between a base station and a UE.

In one embodiment, an air interface between the second node N2 and the first node U1 includes a radio interface between a relay node and a UE.

In one embodiment, an air interface between the second node N2 and the first node U1 includes a radio interface between a UE and another UE.

In one embodiment, the second node N2 is a maintenance base station for a serving cell of the first node U1.

In one embodiment, steps in the box F51 in FIG. 5 are present: a method applicable for the first node U1 in this application comprises: receiving a first information block.

In one embodiment, the first information block is used to configure or trigger a CSI report being associated with the target reference signal resource, the CSI report including the CSI.

In one embodiment, the first information block is transmitted via a higher layer signaling.

In one embodiment, the first information block is transmitted via a Radio Resource Control (RRC) signaling.

In one embodiment, the first information block comprises one or more RRC Information Elements (IEs).

In one embodiment, the first information block comprises one or more fields in at least one RRC IE.

In one embodiment, the first information block comprises information in all or part of fields in each one of multiple RRC IEs.

In one embodiment, the first information block comprises a CSI-AperiodicTriggerStateList IE.

In one embodiment, the first information block comprises one or more fields in a CSI-AperiodicTriggerStateList IE.

In one embodiment, the first information block comprises a CSI-IM-Resource IE.

In one embodiment, the first information block comprises one or more fields in a CSI-IM-Resource IE.

In one embodiment, the first information block comprises a CSI-IM-ResourceSet IE.

In one embodiment, the first information block comprises one or more fields in a CSI-IM-ResourceSet IE.

In one embodiment, the first information block comprises a CSI-MeasConfig IE.

In one embodiment, the first information block comprises one or more fields in a CSI-MeasConfig IE.

In one embodiment, the first information block comprises a CSI-ReportConfig IE.

In one embodiment, the first information block comprises one or more fields in a CSI-ReportConfig IE.

In one embodiment, the first information block comprises a CSI-ResourceConfig IE.

In one embodiment, the first information block comprises one or more fields in a CSI-ResourceConfig IE.

In one embodiment, the first information block comprises an NZP-CSI-RS-Resource IE.

In one embodiment, the first information block comprises one or more fields in an NZP-CSI-RS-Resource IE.

In one embodiment, the first information block comprises an NZP-CSI-RS-ResourceSet IE.

In one embodiment, the first information block comprises one or more fields in an NZP-CSI-RS-ResourceSet IE.

In one embodiment, the first information block is transmitted via a Medium Access Control layer Control Element (MAC CE).

In one embodiment, the first information block comprises an SP CSI-RS/CSI-IM Resource Set Activation/Deactivation MAC CE.

In one embodiment, the first information block comprises an SP ZP CSI-RS Resource Set Activation/Deactivation MAC CE.

In one embodiment, the first information block comprises an SP CSI reporting on PUCCH Activation/Deactivation MAC CE.

In one embodiment, the first information block is transmitted via Downlink Control Information (DCI).

In one subembodiment, the Cyclic Redundancy Check (CRC) of the DCI is scrambled by a Semi-Persistent (SP)-CSI-Radio Network Temporary Identifier (RNTI).

In one subembodiment, the format of the DCI is DCI format 0_1 or DCI format 0_2.

In one embodiment, the first information block is used to configure or trigger a CSI report being associated with the target reference signal resource.

In one embodiment, the first information block is used to configure a CSI report being associated with the target reference signal resource.

In one embodiment, the first information block is used to trigger a CSI report being associated with the target reference signal resource.

In one embodiment, the first information block comprises configuration information for a CSI report being associated with the target reference signal resource.

In one embodiment, the steps in box F51 in FIG. 5 are not present.

In one embodiment, the steps in box F51 in FIG. 5 are present, the step S520 being after the step S5210 and the step S510 being after the step S5110.

In one embodiment, the step S521 is after the step S520; and the step S511 is after the step S510.

In one embodiment, the first information block is transmitted on a downlink physical data channel (i.e., a downlink channel capable of bearing physical layer data).

In one embodiment, a physical layer channel occupied by the first information block includes a Physical Downlink Shared CHannel (PDSCH).

In one embodiment, the first information block is transmitted on a downlink physical control channel (i.e., a downlink channel only capable of bearing physical layer signaling).

In one embodiment, a physical layer channel occupied by the first information block includes a Physical Downlink Control CHannel (PDCCH).

In one embodiment, the CSI is transmitted on an uplink physical control channel (i.e., an uplink channel only capable of carrying physical layer control signaling).

In one embodiment, a physical layer channel occupied by the CSI includes a Physical Uplink Control CHannel (PUCCH).

In one embodiment, the CSI is transmitted on an uplink physical data channel (i.e. an uplink channel capable of carrying physical layer data).

In one embodiment, a physical layer channel occupied by the CSI includes a Physical Uplink Shared CHannel (PUSCH).

In one embodiment, a transport channel corresponding to the CSI includes an UpLink-Shared CHannel (UL-SCH).

### Embodiment 6

Embodiment 6 illustrates a schematic diagram of reception power of a first reference signal, reception power of a second reference signal and a first threshold according to one embodiment of the present application, as shown in FIG. 6. In FIG. 6, the horizontal axis represents the reception power: the diamond-filled area represents in power the reception power of a first reference signal, the reception power of the first reference signal being equal to a first power value; and the cross-filled area represents in power the reception power of a second reference signal, the reception power of the second reference signal being equal to a second power value.

In Embodiment 6, an absolute value of a difference between the first power value and the second power value is greater than a first threshold, and the measurement of the second reference signal is not used to generate the CSI: or, the absolute value of the difference between the first power value and the second power value is no greater than the first threshold, and the measurement of the second reference signal is used to generate the CSI.

In one embodiment, the reception power of the first reference signal is equal to a first power value, while the reception power of the second reference signal is equal to a second power value: an absolute value of a difference between the first power value and the second power value is greater than a first threshold, and the measurement of the second reference signal is not used to generate the CSI; or, the absolute value of the difference between the first power value and the second power value is no greater than the first threshold, and the measurement of the second reference signal is used to generate the CSI.

In one embodiment, the first power value is measured in dBm.

In one embodiment, the second power value is measured in dBm.

In one embodiment, the first power value is measured in mW.

In one embodiment, the second power value is measured in mW.

In one embodiment, the first power value is measured in dB.

In one embodiment, the second power value is measured in dB.

In one embodiment, the value of the first threshold is equal to 0.

In one embodiment, the value of the first threshold is a positive number.

In one embodiment, the first threshold is fixed.

In one embodiment, the first threshold is pre-defined.

In one embodiment, the first threshold is configured via a higher layer signaling.

In one embodiment, the first threshold is configured via an RRC layer signaling.

### Embodiment 7

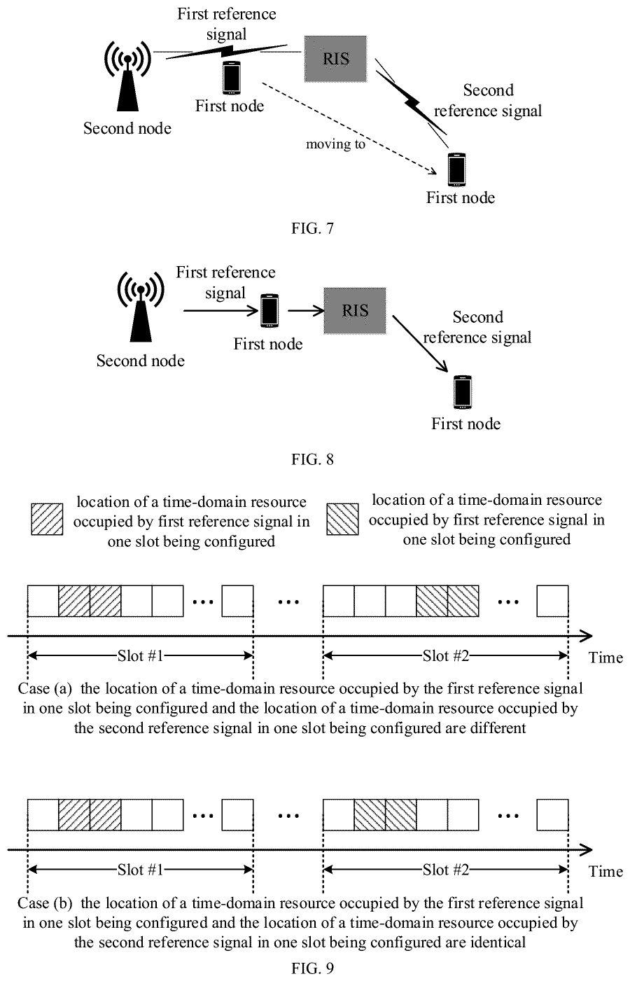

Embodiment 7 illustrates a schematic diagram of a case of locational change for the first node when receiving a first reference signal and a second reference signal according to one embodiment of the present application, as shown in FIG. 7. In FIG. 7, the location-related information of the first node comprises location-related information corresponding to a location of the first node when receiving the first reference signal and location-related information corresponding to a location of the first node when receiving the second reference signal.

In FIG. 7, there is a change between location-related information corresponding to the first node when receiving the first reference signal and location-related information corresponding to the first node when receiving the second reference signal, and the measurement of the second reference signal is not used to generate the CSI: or, there is no change between the location-related information corresponding to the first node when receiving the first reference signal and the location-related information corresponding to the first node when receiving the second reference signal, and the measurement of the second reference signal is used to generate the CSI.

In one embodiment, the location-related information corresponding to the first node when receiving the first reference signal comprises: a distance from a second node in the present application to the first node when receiving the first reference signal.

In one embodiment, the location-related information corresponding to the first node when receiving the second reference signal comprises: a distance from a second node in the present application to the first node when receiving the second reference signal.

In one subembodiment of the above two embodiments, a change between a distance from the second node to the first node when receiving the first reference signal and a distance from the second node to the first node when receiving the second reference signal is greater than a given threshold, and the measurement of the second reference signal is not used to generate the CSI: or, a change between a distance from the second node to the first node when receiving the first reference signal and a distance from the second node to the first node when receiving the second reference signal is not greater than the given threshold, and the measurement of the second reference signal is used to generate the CSI.

In one embodiment, the location-related information corresponding to the first node when receiving the first reference signal comprises: an Angle of Departure (AoD) corresponding to the first reference signal when the first node receives the first reference signal.

In one embodiment, the location-related information corresponding to the first node when receiving the second reference signal comprises: an AoD corresponding to the second reference signal when the first node receives the second reference signal.

In one subembodiment of the above two embodiments, the AoD corresponding to the first reference signal when the first node receives the first reference signal is different from the AoD corresponding to the second reference signal when the first node receives the second reference signal, and the measurement of the second reference signal is not used to generate the CSI: or, the AoD corresponding to the first reference signal when the first node receives the first reference signal is the same as the AoD corresponding to the second reference signal when the first node receives the second reference signal, and the measurement of the second reference signal is used to generate the CSI.

In one embodiment, the location-related information of the first node is related to an area identification corresponding to the first node.

In one subembodiment, the area identification is a cell ID.

In one subembodiment, the area identification is a non-negative integer.

In one subembodiment, the area identification corresponds to a pair of integers, which are respectively used to indicate a horizontal position and a vertical position of the first node relative to a reference point.

In one subembodiment, the area identification corresponds to a pair of integers, which are respectively used to indicate a longitude position and a dimensional position of the first node relative to a reference point.

In one subembodiment, the area identification corresponds to a pair of integers, which are respectively used to indicate a lateral position and a longitudinal position of the first node relative to a reference point.

In one subembodiment, the area identification corresponds to three integers, which are respectively used to indicate a horizontal position, a vertical position and a height of the first node relative to a reference point.

In one subembodiment, the area identification corresponds to three integers, which are respectively used to indicate a lateral position, a longitudinal position and a height of the first node relative to a reference point.

In one subsidiary embodiment of the above five subembodiments, the reference point is the second node in the present application.

In one subsidiary embodiment of the above five subembodiments, the reference point is fixed.

In one embodiment, there is a change between an area identification corresponding to the first node when receiving the first reference signal and location-related information corresponding to the first node when receiving the second reference signal, and the measurement of the second reference signal is not used to generate the CSI: or, there is no change between the location-related information corresponding to the first node when receiving the first reference signal and the location-related information corresponding to the first node when receiving the second reference signal, and the measurement of the second reference signal is used to generate the CSI.

In one embodiment, when the first node falls within an area identification while receiving the first reference signal and does not fall within an area identification while receiving the second reference signal, the measurement of the second reference signal is not used to generate the CSI: or, when the first node does not fall within an area identification while receiving the first reference signal and falls within an area identification while receiving the second reference signal, the measurement of the second reference signal is not used to generate the CSI: or, when the first node falls within an area identification both while receiving the first reference signal and receiving the second reference signal, the measurement of the second reference signal is used to generate the CSI: or, when the first node does not fall within an area identification both while receiving the first reference signal and receiving the second reference signal, the measurement of the second reference signal is used to generate the CSI.

### Embodiment 8

Embodiment 8 illustrates a schematic diagram of a case of change in spatial Rx parameters for the first node when receiving a first reference signal and a second reference signal according to one embodiment of the present application, as shown in FIG. 8.

In one embodiment, the spatial Rx parameter(s) corresponding to the first reference signal includes (include) a receiving beam employed by the first node when receiving the first reference signal; the spatial Rx parameter(s) corresponding to the second reference signal includes (include) a receiving beam employed by the first node when receiving the second reference signal.

In one subembodiment, the receiving beam employed by the first node when receiving the first reference signal is different from the receiving beam employed by the first node when receiving the second reference signal, and the measurement of the second reference signal is not used to generate the CSI: or, the receiving beam employed by the first node when receiving the first reference signal is the same as the receiving beam employed by the first node when receiving the second reference signal, and the measurement of the second reference signal is used to generate the CSI.

In one embodiment, the spatial Rx parameter(s) corresponding to the first reference signal includes (include) a receiving beamforming vector employed by the first node when receiving the first reference signal: the spatial Rx parameter(s) corresponding to the second reference signal includes (include) a receiving beamforming vector employed by the first node when receiving the second reference signal.

In one subembodiment, the receiving beamforming vector employed by the first node when receiving the first reference signal is different from the receiving beamforming vector employed by the first node when receiving the second reference signal, and the measurement of the second reference signal is not used to generate the CSI: or, the receiving beamforming vector employed by the first node when receiving the first reference signal is the same as the receiving beamforming vector employed by the first node when receiving the second reference signal, and the measurement of the second reference signal is used to generate the CSI.

In one embodiment, the spatial Rx parameter(s) corresponding to the first reference signal includes (include) a receiving beamforming matrix employed by the first node when receiving the first reference signal: the spatial Rx parameter(s) corresponding to the second reference signal includes (include) a receiving beamforming matrix employed by the first node when receiving the second reference signal.

In one subembodiment, the receiving beamforming matrix employed by the first node when receiving the first reference signal is different from the receiving beamforming matrix employed by the first node when receiving the second reference signal, and the measurement of the second reference signal is not used to generate the CSI: or, the receiving beamforming matrix employed by the first node when receiving the first reference signal is the same as the receiving beamforming matrix employed by the first node when receiving the second reference signal, and the measurement of the second reference signal is used to generate the CSI.

In one embodiment, the spatial Rx parameter(s) corresponding to the first reference signal includes (include) a receiving analog beamforming matrix employed by the first node when receiving the first reference signal: the spatial Rx parameter(s) corresponding to the second reference signal includes (include) a receiving analog beamforming matrix employed by the first node when receiving the second reference signal.

In one subembodiment, the receiving analog beamforming matrix employed by the first node when receiving the first reference signal is different from the receiving analog beamforming matrix employed by the first node when receiving the second reference signal, and the measurement of the second reference signal is not used to generate the CSI: or, the receiving analog beamforming matrix employed by the first node when receiving the first reference signal is the same as the receiving analog beamforming matrix employed by the first node when receiving the second reference signal, and the measurement of the second reference signal is used to generate the CSI.

In one embodiment, the spatial Rx parameter(s) corresponding to the first reference signal includes (include) a spatial reception filter employed by the first node when receiving the first reference signal; the spatial Rx parameter(s) corresponding to the second reference signal includes (include) a spatial reception filter employed by the first node when receiving the second reference signal.

In one subembodiment, the spatial reception filter employed by the first node when receiving the first reference signal is different from the spatial reception filter employed by the first node when receiving the second reference signal, and the measurement of the second reference signal is not used to generate the CSI: or, the spatial reception filter employed by the first node when receiving the first reference signal is the same as the spatial reception filter employed by the first node when receiving the second reference signal, and the measurement of the second reference signal is used to generate the CSI.

In one embodiment, the spatial Rx parameter(s) corresponding to the first reference signal includes (include) a panel employed by the first node when receiving the first reference signal: the spatial Rx parameter(s) corresponding to the second reference signal includes (include) a panel employed by the first node when receiving the second reference signal.

In one subembodiment, the panel employed by the first node when receiving the first reference signal is different from the panel employed by the first node when receiving the second reference signal, and the measurement of the second reference signal is not used to generate the CSI: or, the panel employed by the first node when receiving the first reference signal is the same as the panel employed by the first node when receiving the second reference signal, and the measurement of the second reference signal is used to generate the CSI.

In one embodiment, the spatial Rx parameter(s) corresponding to the first reference signal includes (include) an AoD corresponding to the first reference signal: the spatial Rx parameter(s) corresponding to the second reference signal includes (include) an AoD corresponding to the second reference signal.

### Embodiment 9

Embodiment 9 illustrates a schematic diagram of two cases of locations of time-domain resources respectively occupied in a configured slot by a first reference signal and a second reference signal according to one embodiment of the present application, as shown in FIG. 9. In FIG. 9, a rectangle denotes a multicarrier symbol, an upper diagonally filled rectangle denotes a multicarrier symbol of a time-domain resource occupied by a first reference signal in one slot being configured: an upper diagonally filled rectangle denotes a multicarrier symbol of a time-domain resource occupied by a second reference signal in one slot being configured: it is worth noting that the present figure is for exemplary illustration only, and does not denote the number of multicarrier symbols actually occupied by the first reference signal and the second reference signal in the configured one slot.

In Embodiment 9, case (a) denotes that the location of a time-domain resource occupied by the first reference signal in one slot being configured and the location of a time-domain resource occupied by the second reference signal in one slot being configured are different: case (b) denotes that the location of a time-domain resource occupied by the first reference signal in one slot being configured and the location of a time-domain resource occupied by the second reference signal in one slot being configured are identical.

In one embodiment, a length of a time-domain resource occupied by the first reference signal in one slot being configured is the same as a length of a time-domain resource occupied by the second reference signal in one slot being configured.

In one embodiment, a location of a time-domain resource occupied by the first reference signal in one slot being configured is the same as a location of a time-domain resource occupied by the second reference signal in one slot being configured.

In one embodiment, a location of a time-domain resource occupied by the first reference signal in one slot being configured is different from a location of a time-domain resource occupied by the second reference signal in one slot being configured.

In one embodiment, a location of a time-domain resource occupied by the first reference signal in one slot being configured includes: a location of a multicarrier symbol occupied by the first reference signal in one slot being configured.

In one embodiment, a location of a time-domain resource occupied by the second reference signal in one slot being configured includes: a location of a multicarrier symbol occupied by the second reference signal in one slot being configured.

In one subembodiment of the above two embodiments, the location of the multicarrier symbol occupied by the first reference signal in one slot and the location of the multicarrier symbol occupied by the second reference signal in one slot are different, and the measurement of the second reference signal is not used to generate the CSI: or, the location of the multicarrier symbol occupied by the first reference signal in one slot and the location of the multicarrier symbol occupied by the second reference signal in one slot are identical, and the measurement of the second reference signal is used to generate the CSI.

In one embodiment, the location of a time-domain resource occupied by the first reference signal in one slot being configured includes: the location of a slot occupied by the first reference signal in one period being configured.

In one embodiment, the location of a time-domain resource occupied by the second reference signal in one slot being configured includes: the location of a slot occupied by the second reference signal in one period being configured.

In one subembodiment of the above two embodiments, the location of the multicarrier symbol occupied by the first reference signal in one slot and the location of the multicarrier symbol occupied by the second reference signal in one slot are different, and the measurement of the second reference signal is not used to generate the CSI: or, the location of the multicarrier symbol occupied by the first reference signal in one slot and the location of the multicarrier symbol occupied by the second reference signal in one slot are identical, and the measurement of the second reference signal is used to generate the CSI.

### Embodiment 10

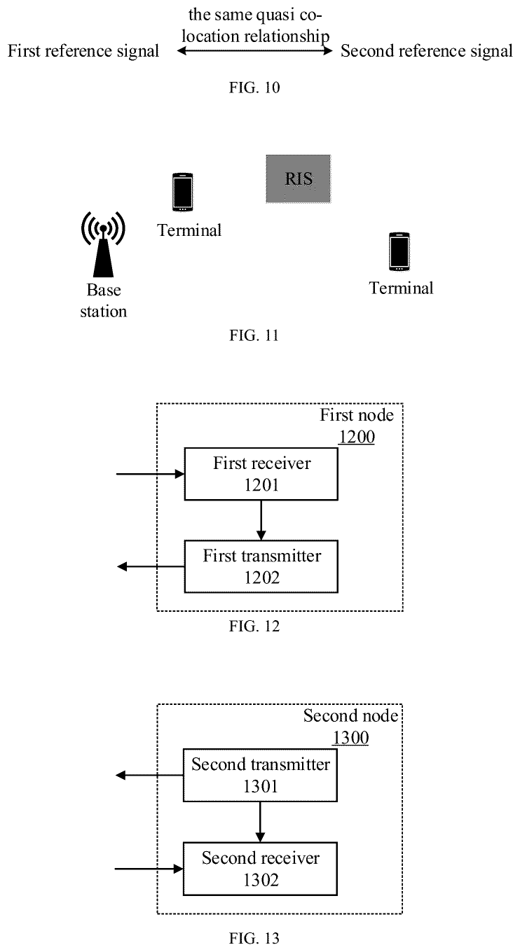

Embodiment 10 illustrates a schematic diagram of the quasi co-location relationship between a first reference signal and a second reference signal according to one embodiment of the present application, as shown in FIG. 10. In FIG. 10, the first reference signal and the second reference signal correspond to the same quasi co-location relationship.

In one embodiment, the feature “the first reference signal and the second reference signal correspond to the same quasi co-location relationship” comprises that the first reference signal and the second reference signal correspond to a same TCI state.

In one embodiment, the feature “the first reference signal and the second reference signal correspond to the same quasi co-location relationship” comprises that the first reference signal and the second reference signal are both quasi co-located with a same RS resource.

In one embodiment, the feature “the first reference signal and the second reference signal correspond to the same quasi co-location relationship” comprises that the first reference signal and the second reference signal are both quasi co-located with a same RS.

In one embodiment, the QCL-type corresponding to the quasi-co-location relationship is one of TypeA, TypeB, TypeC or TypeD

### Embodiment 11

Embodiment 11 illustrates a schematic diagram of Reconfigurable Intelligence Surface (RIS) according to one embodiment of the present application, as shown in FIG. 11. In FIG. 11, the RIS refers to: Reconfigurable Intelligent Surface.

In one embodiment, a transmission path of the first reference signal includes a link consisting of an incident link from a base station to RIS and a reflective link from RIS to a terminal, and a transmission path of the second reference signal includes a link consisting of an incident link from a base station to RIS and a reflective link from RIS to a terminal.

In one embodiment, a transmission path of the first reference signal includes a link consisting of an incident link from a base station to RIS and a reflective link from RIS to a terminal, while a transmission path of the second reference signal includes a direct link from a base station to a terminal.

In one embodiment, a transmission path of the first reference signal includes a direct link from a base station to a terminal, while a transmission path of the second reference signal includes a link consisting of an incident link from a base station to RIS and a reflective link from RIS to a terminal.

In one embodiment, a transmission path of the first reference signal includes a direct link from a base station to a terminal, and a transmission path of the second reference signal includes a direct link from a base station to a terminal.

### Embodiment 12

Embodiment 12 illustrates a structure block diagram of a processing device used in a first node according to one embodiment of the present application, as shown in FIG. 12. In FIG. 12, a processing device 1200 in a first node is comprised of a first receiver 1201 and a first transmitter 1202.

In Embodiment 12, the first receiver 1201 receives a first reference signal and a second reference signal, a time-frequency resource occupied by the first reference signal and a time-frequency resource occupied by the second reference signal being both associated with a target reference signal resource; the first transmitter 1202 transmits channel state information (CSI).

In Embodiment 12, a measurement of the first reference signal is used to generate the CSI, and the second reference signal is no later than a CSI reference resource for the CSI in time domain; whether a measurement of the second reference signal is used to generate the CSI depends on one of the following:
power-related information of the first reference signal and power-related information of the second reference signal;
location-related information of the first node;
spatial reception (Rx) parameter(s) corresponding to the first reference signal and spatial Rx parameter(s) corresponding to the second reference signal: or
a time-domain resource occupied by the first reference signal and a time-domain resource occupied by the second reference signal.

In one embodiment, the reception power of the first reference signal is equal to a first power value, while the reception power of the second reference signal is equal to a second power value: an absolute value of a difference between the first power value and the second power value is greater than a first threshold, and the measurement of the second reference signal is not used to generate the CSI: or, the absolute value of the difference between the first power value and the second power value is no greater than the first threshold, and the measurement of the second reference signal is used to generate the CSI.

In one embodiment, there is a change between location-related information corresponding to the first node when receiving the first reference signal and location-related information corresponding to the first node when receiving the second reference signal, and the measurement of the second reference signal is not used to generate the CSI: or, there is no change between the location-related information corresponding to the first node when receiving the first reference signal and the location-related information corresponding to the first node when receiving the second reference signal, and the measurement of the second reference signal is used to generate the CSI.

In one embodiment, the spatial Rx parameter(s) corresponding to the first reference signal and the spatial Rx parameter(s) corresponding to the second reference signal are different, and the measurement of the second reference signal is not used to generate the CSI: or, the spatial Rx parameter(s) corresponding to the first reference signal and the spatial Rx parameter(s) corresponding to the second reference signal are identical, and the measurement of the second reference signal is used to generate the CSI.

In one embodiment, a location of a time-domain resource occupied by the first reference signal in one slot being configured and a location of a time-domain resource occupied by the second reference signal in one slot being configured are different, and the measurement of the second reference signal is not used to generate the CSI: or, a location of a time-domain resource occupied by the first reference signal in one slot being configured and a location of a time-domain resource occupied by the second reference signal in one slot being configured are identical, and the measurement of the second reference signal is used to generate the CSI.

In one embodiment, the first receiver 1201 receives a first information block; the first information block is used to configure or trigger a CSI report being associated with the target reference signal resource, the CSI report including the CSI.

In one embodiment, the first reference signal and the second reference signal correspond to the same quasi co-location relationship.

In one embodiment, the location-related information of the first node comprises location-related information corresponding to a location of the first node when receiving the first reference signal and location-related information corresponding to a location of the first node when receiving the second reference signal.

In one embodiment, the power-related information of the first reference signal comprises a transmission power value of the first reference signal and the power-related information of the second reference signal comprises a transmission power value of the second reference signal.

In one embodiment, the spatial Rx parameter(s) corresponding to the first reference signal includes (include) at least one of a receiving beam, a receiving analog beamforming matrix, a receiving analog beamforming vector, a receiving beamforming matrix, a receiving beamforming vector, or a spatial reception filter employed by the first node when receiving the first reference signal: the spatial Rx parameter(s) corresponding to the second reference signal includes (include) at least one of a receiving beam, a receiving analog beamforming matrix, a receiving analog beamforming vector, a receiving beamforming matrix, a receiving beamforming vector, or a spatial reception filter employed by the first node when receiving the second reference signal.

In one embodiment, the time-domain resource occupied by the first reference signal comprises a location of a multicarrier symbol occupied by the first reference signal in one slot, while the time-domain resource occupied by the second reference signal comprises a location of a multicarrier symbol occupied by the second reference signal in one slot.

In one embodiment, the time-domain resource occupied by the first reference signal comprises a location of a slot occupied by the first reference signal in one configuration period, while the time-domain resource occupied by the second reference signal comprises a location of a slot occupied by the second reference signal in one configuration period.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1202 comprises at least one of the antenna 452, the transmitter 454, the transmitting processor 468, the multi-antenna transmitting processor 457, the controller/processor 459, the memory 460 or the data source 467 in Embodiment 4.

### Embodiment 13

Embodiment 13 illustrates a structure block diagram of a processing device used in a second node according to one embodiment of the present application, as shown in FIG. 13. In FIG. 13, a processing device 1300 in a second node is comprised of a second transmitter 1301 and a second receiver 1302.

In Embodiment 13, the second transmitter 1301 transmits a first reference signal and a second reference signal, a time-frequency resource occupied by the first reference signal and a time-frequency resource occupied by the second reference signal being both associated with a target reference signal resource: the second receiver 1302 receives channel state information (CSI).

In Embodiment 13, a receiver of the first reference signal and the second reference signal includes a first node: a measurement of the first reference signal is used by the first node to generate the CSI, and the second reference signal is no later than a CSI reference resource for the CSI in time domain: whether a measurement of the second reference signal from the first node is used by the first node to generate the CSI depends on one of the following:
power-related information of the first reference signal and power-related information of the second reference signal;
location-related information of the first node;
spatial reception (Rx) parameter(s) corresponding to the first reference signal and spatial Rx parameter(s) corresponding to the second reference signal: or
a time-domain resource occupied by the first reference signal and a time-domain resource occupied by the second reference signal.

In one embodiment, the reception power of the first reference signal is equal to a first power value, while the reception power of the second reference signal is equal to a second power value: an absolute value of a difference between the first power value and the second power value is greater than a first threshold, and the measurement of the second reference signal is not used to generate the CSI: or, the absolute value of the difference between the first power value and the second power value is no greater than the first threshold, and the measurement of the second reference signal is used to generate the CSI.

In one embodiment, there is a change between location-related information corresponding to the first node when receiving the first reference signal and location-related information corresponding to the first node when receiving the second reference signal, and the measurement of the second reference signal is not used to generate the CSI: or, there is no change between the location-related information corresponding to the first node when receiving the first reference signal and the location-related information corresponding to the first node when receiving the second reference signal, and the measurement of the second reference signal is used to generate the CSI.

In one embodiment, the spatial Rx parameter(s) corresponding to the first reference signal and the spatial Rx parameter(s) corresponding to the second reference signal are different, and the measurement of the second reference signal is not used to generate the CSI: or, the spatial Rx parameter(s) corresponding to the first reference signal and the spatial Rx parameter(s) corresponding to the second reference signal are identical, and the measurement of the second reference signal is used to generate the CSI.

In one embodiment, a location of a time-domain resource occupied by the first reference signal in one slot being configured and a location of a time-domain resource occupied by the second reference signal in one slot being configured are different, and the measurement of the second reference signal is not used to generate the CSI: or, a location of a time-domain resource occupied by the first reference signal in one slot being configured and a location of a time-domain resource occupied by the second reference signal in one slot being configured are identical, and the measurement of the second reference signal is used to generate the CSI.

In one embodiment, the second transmitter 1301 transmits a first information block; the first information block is used to configure or trigger a CSI report being associated with the target reference signal resource, the CSI report including the CSI.

In one embodiment, the first reference signal and the second reference signal correspond to the same quasi co-location relationship.

In one embodiment, the location-related information of the receiver of the first reference signal and the second reference signal comprises location-related information corresponding to a location of the receiver of the first reference signal and the second reference signal when receiving the first reference signal and location-related information corresponding to a location of the receiver of the first reference signal and the second reference signal when receiving the second reference signal.

In one embodiment, the power-related information of the first reference signal comprises a transmission power value of the first reference signal and the power-related information of the second reference signal comprises a transmission power value of the second reference signal.

In one embodiment, the spatial Rx parameter(s) corresponding to the first reference signal includes (include) at least one of a receiving beam, a receiving analog beamforming matrix, a receiving analog beamforming vector, a receiving beamforming matrix, a receiving beamforming vector, or a spatial reception filter employed by the first node when receiving the first reference signal: the spatial Rx parameter(s) corresponding to the second reference signal includes (include) at least one of a receiving beam, a receiving analog beamforming matrix, a receiving analog beamforming vector, a receiving beamforming matrix, a receiving beamforming vector, or a spatial reception filter employed by the first node when receiving the second reference signal.

In one embodiment, the time-domain resource occupied by the first reference signal comprises a location of a multicarrier symbol occupied by the first reference signal in one slot, while the time-domain resource occupied by the second reference signal comprises a location of a multicarrier symbol occupied by the second reference signal in one slot.

In one embodiment, the time-domain resource occupied by the first reference signal comprises a location of a slot occupied by the first reference signal in one configuration period, while the time-domain resource occupied by the second reference signal comprises a location of a slot occupied by the second reference signal in one configuration period.

In one embodiment, the second node is a base station.

In one embodiment, the second node is a UE.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475 or the memory 476 in Embodiment 4.

In one embodiment, the second receiver 1302 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, vehicles, automobiles, RSU, wireless sensor, network cards, terminals for Internet of Things (IoT), Radio Frequency Identification (RFID) terminals, Narrow Band Internet of Things (NB-IoT) terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, evolved Node B/eNB, gNB, Transmitter Receiver Point (TRP), Global Navigation Satellite System (GNSS), relay satellite, satellite base station, airborne base station, Road Side Unit (RSU), drones, test equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first reference signal and a second reference signal, a time-frequency resource occupied by the first reference signal and a time-frequency resource occupied by the second reference signal being both associated with a target reference signal resource; and
a first transmitter, transmitting channel state information (CSI);
wherein a measurement of the first reference signal is used to generate the CSI, and the second reference signal is no later than a CSI reference resource for the CSI in time domain; whether a measurement of the second reference signal is used to generate the CSI depends on one of the following:
power-related information of the first reference signal and power-related information of the second reference signal;
location-related information of the first node;
spatial reception (Rx) parameter(s) corresponding to the first reference signal and spatial Rx parameter(s) corresponding to the second reference signal: or
a time-domain resource occupied by the first reference signal and a time-domain resource occupied by the second reference signal.

2. The first node according to claim 1, characterized in that reception power of the first reference signal is equal to a first power value, while reception power of the second reference signal is equal to a second power value: an absolute value of a difference between the first power value and the second power value is greater than a first threshold, and the measurement of the second reference signal is not used to generate the CSI: or, the absolute value of the difference between the first power value and the second power value is no greater than the first threshold, and the measurement of the second reference signal is used to generate the CSI.

3. The first node according to claim 1, characterized in that there is a change between location-related information corresponding to the first node when receiving the first reference signal and location-related information corresponding to the first node when receiving the second reference signal, and the measurement of the second reference signal is not used to generate the CSI: or, there is no change between the location-related information corresponding to the first node when receiving the first reference signal and the location-related information corresponding to the first node when receiving the second reference signal, and the measurement of the second reference signal is used to generate the CSI.

4. The first node according to claim 1, characterized in that the spatial Rx parameter(s) corresponding to the first reference signal and the spatial Rx parameter(s) corresponding to the second reference signal are different, and the measurement of the second reference signal is not used to generate the CSI: or, the spatial Rx parameter(s) corresponding to the first reference signal and the spatial Rx parameter(s) corresponding to the second reference signal are identical, and the measurement of the second reference signal is used to generate the CSI.

5. The first node according to claim 1, characterized in that a location of a time-domain resource occupied by the first reference signal in one slot being configured and a location of a time-domain resource occupied by the second reference signal in one slot being configured are different, and the measurement of the second reference signal is not used to generate the CSI: or, a location of a time-domain resource occupied by the first reference signal in one slot being configured and a location of a time-domain resource occupied by the second reference signal in one slot being configured are identical, and the measurement of the second reference signal is used to generate the CSI.

6. The first node according to claim 1, characterized in comprising:
the first receiver, receiving a first information block;
wherein the first information block is used to configure or trigger a CSI report being associated with the target reference signal resource, the CSI report including the CSI.

7. The first node according to claim 1, characterized in that the first reference signal and the second reference signal correspond to a same quasi co-location relationship.

8. The first node according to claim 1, characterized in that the first reference signal and the second reference signal are both transmitted according to configuration information for the target reference signal resource.

9. The first node according to claim 1, characterized in that both of the first reference signal and the second reference signal belong to one transmission of a reference signal according to configuration information for the target reference signal resource.

10. The first node according to claim 1, characterized in that the target reference signal resource corresponds to a CSI-RS resource.

11. The first node according to claim 1, characterized in that the target reference signal resource corresponds to an RS resource Id.

12. The first node according to claim 3, characterized in that the location-related information corresponding to the first node when receiving the first reference signal includes:
a distance from a second node in the present application to the first node when receiving the first reference signal;
while the location-related information corresponding to the first node when receiving the second reference signal includes;
a distance from a second node in the present application to the first node when receiving the second reference signal.

13. The first node according to claim 3, characterized in that the location-related information corresponding to the first node when receiving the first reference signal includes:
an Angle of Departure (AoD) corresponding to the first reference signal when the first node is receiving the first reference signal;
while the location-related information corresponding to the first node when receiving the second reference signal includes:
an AoD corresponding to the second reference signal when the first node is receiving the second reference signal.

14. The first node according to claim 1, characterized in that a transmission path of the first reference signal includes a direct link from a base station to a terminal, while a transmission path of the second reference signal includes a link consisting of an incident link from a base station to RIS and a reflective link from RIS to a terminal.

15. The first node according to claim 1, characterized in that a transmission path of the first reference signal includes a link consisting of an incident link from a base station to RIS and a reflective link from RIS to a terminal, while a transmission path of the second reference signal includes a direct link from a base station to a terminal.

16. A second node for wireless communications, comprising:
a second transmitter, transmitting a first reference signal and a second reference signal, a time-frequency resource occupied by the first reference signal and a time-frequency resource occupied by the second reference signal being both associated with a target reference signal resource; and
a second receiver, receiving channel state information (CSI);
wherein a receiver of the first reference signal and the second reference signal includes a first node; a measurement of the first reference signal is used by the first node to generate the CSI, and the second reference signal is no later than a CSI reference resource for the CSI in time domain; whether a measurement of the second reference signal from the first node is used by the first node to generate the CSI depends on one of the following:
power-related information of the first reference signal and power-related information of the second reference signal;
location-related information of the first node;
spatial reception (Rx) parameter(s) corresponding to the first reference signal and spatial Rx parameter(s) corresponding to the second reference signal: or
a time-domain resource occupied by the first reference signal and a time-domain resource occupied by the second reference signal.

17. The second node according to claim 16, characterized in that reception power of the first reference signal is equal to a first power value, while reception power of the second reference signal is equal to a second power value: an absolute value of a difference between the first power value and the second power value is greater than a first threshold, and the measurement of the second reference signal is not used to generate the CSI: or, the absolute value of the difference between the first power value and the second power value is no greater than the first threshold, and the measurement of the second reference signal is used to generate the CSI.

18. The second node according to claim 16, characterized in that there is a change between location-related information corresponding to the first node when receiving the first reference signal and location-related information corresponding to the first node when receiving the second reference signal, and the measurement of the second reference signal is not used to generate the CSI: or, there is no change between the location-related information corresponding to the first node when receiving the first reference signal and the location-related information corresponding to the first node when receiving the second reference signal, and the measurement of the second reference signal is used to generate the CSI.

19. The second node according to claim 16, characterized in that the spatial Rx parameter(s) corresponding to the first reference signal and the spatial Rx parameter(s) corresponding to the second reference signal are different, and the measurement of the second reference signal is not used to generate the CSI: or, the spatial Rx parameter(s) corresponding to the first reference signal and the spatial Rx parameter(s) corresponding to the second reference signal are identical, and the measurement of the second reference signal is used to generate the CSI:
or, characterized in that a location of a time-domain resource occupied by the first reference signal in one slot being configured and a location of a time-domain resource occupied by the second reference signal in one slot being configured are different, and the measurement of the second reference signal is not used to generate the CSI: or, a location of a time-domain resource occupied by the first reference signal in one slot being configured and a location of a time-domain resource occupied by the second reference signal in one slot being configured are identical, and the measurement of the second reference signal is used to generate the CSI.

20. A method in a first node for wireless communications, comprising:
receiving a first reference signal and a second reference signal, a time-frequency resource occupied by the first reference signal and a time-frequency resource occupied by the second reference signal being both associated with a target reference signal resource; and
transmitting channel state information (CSI);
wherein a measurement of the first reference signal is used to generate the CSI, and the second reference signal is no later than a CSI reference resource for the CSI in time domain; whether a measurement of the second reference signal is used to generate the CSI depends on one of the following:
power-related information of the first reference signal and power-related information of the second reference signal;
location-related information of the first node;
spatial reception (Rx) parameter(s) corresponding to the first reference signal and spatial Rx parameter(s) corresponding to the second reference signal; or
a time-domain resource occupied by the first reference signal and a time-domain resource occupied by the second reference signal.
